(19) United States
(12) Patent Application Publication
(10) Pub. No.: US 2004/0253894 A1
(43) Pub. Date: Dec. 16, 2004

(54) Three dimensionally patterned stabilized absorbent material and method for producing same

(76) Inventors: David A. Fell, Neenah, WI (US); Andrew T. Baker, Norcross, GA (US); Stephen A. Baratian, Roswell, GA (US)

Correspondence Address: BRINKS HOFER GILSON & LIONE, P.O. BOX 10395, CHICAGO, IL, 60610, US

(21) Appl. No.: 10/462,067

(22) Filed: Jun. 13, 2003

(51) Int. Cl. B32B 5/26

(52) U.S. Cl. 442/381; 442/382; 442/394; 442/400; 442/417; 428/143

(57) ABSTRACT

An absorbent core for use in an absorbent article such as a diaper, training pant, feminine hygiene product, or an incontinence product includes a three dimensionally patterned stabilized first absorbent layer and a second absorbent layer adjacent the first layer. An upper surface of the first three dimensionally patterned stabilized absorbent layer has a three-dimensional topography relative to the longitudinal and lateral axes and defines a plurality of peaks and valleys of the upper surface relative to the z-direction. A lower surface of the first three dimensionally patterned stabilized absorbent layer has a three-dimensional topography relative to the longitudinal and lateral axes and defines a plurality of the peaks and valleys of the lower surface relative to the z-direction.

### COPYRIGHT NOTICE/AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### COMPUTER PROGRAM LISTING APPENDIX

This application contains one compact disc submitted in duplicate. The material on that compact disc is incorporated herein by reference. Each compact disc contains two computer programs (1) Get Thickness 7 created on the compact discs on Jun. 12, 2003 of file size 12,804 bytes (16,384 bytes on disk) and (2) Whole Analysis 7 created on the compact discs on Jun. 12, 2003 of file size 9,290 bytes (12,288 bytes on disk).

### BACKGROUND OF THE INVENTION

The present invention relates to an absorbent core for use in absorbent articles.

Disposable absorbent articles such as catamenial pads, sanitary napkins, pantyliners, adult incontinence pads and garments, diapers, and children's training pants are designed to be worn adjacent to the wearer's body to absorb body fluids such as menses, blood, urine and other bodily excretions. Users of absorbent articles include menstruating women, infants, children undergoing toilet training, and urine and bowel incontinent adults, among others. This broad user base with varying absorbency requirements has resulted in the development of a broad range of commercial products to meet consumer absorbency needs.

Advantageously and surprisingly, it has been found that an absorbent core that includes a first three dimensionally patterned stabilized layer in combination with a second absorbent layer provides improved intake, rewet, and channeling of liquids. Moreover, the texturing provides a more aesthetically pleasing appearance.

### SUMMARY OF THE INVENTION

Briefly, this invention relates to an absorbent core formed from two or more layers for use in an absorbent article. Non limiting examples of absorbent articles that may use the absorbent core of the present invention include an incontinence pad, pantyliner, diaper, children's training pant, adult incontinence garment, arm pads, bed pads, milk pads, and other articles that are intended to absorb fluids. The absorbent core can be formed from two or more layers of material for providing protection against involuntary loss of body fluids. The absorbent article may include a liquid permeable bodyside liner, a liquid-impermeable baffle, and an absorbent core, which is positioned between the liner and the baffle. Advantageously, articles formed with the absorbent core according to the present invention better resist deformation and maintain their integrity during use.

The absorbent core includes at least a first three dimensionally patterned stabilized absorbent layer and a second absorbent layer adjacent the first layer. As used herein, the term “stabilized absorbent” refers to an absorbent structure or layer that includes binder agents or other materials added to a mixture of other absorbent materials, such as wood pulp fluff and superabsorbent material, when included, to provide an absorbent matrix that has a dry tensile strength of about 6 Newtons/5 cm or more and a wet tensile strength of about 2 Newtons/5 cm or more.

The first three dimensionally patterned stabilized absorbent layer may be provided with any of a variety of texturing patterns, that will impart a three dimensional aspect to the layer (i.e., a three dimensional pattern). For example, the texturing may impart a region or regions having a height (or thickness) greater than the height (or thickness) of other or adjacent regions. Alternatively, the texturing may impart a region or regions having a density greater than the density of other or adjacent regions.

In one aspect of the present invention, an upper surface of the first three dimensionally patterned stabilized absorbent layer has a three-dimensional topography relative to the longitudinal and lateral axes and defines a plurality of peaks and valleys of the upper surface relative to the z-direction. A lower surface of the first three dimensionally patterned stabilized absorbent layer has a three-dimensional topography relative to the longitudinal and lateral axes and defines a plurality of the peaks and valleys of the lower surface relative to the z-direction. The first three dimensionally patterned stabilized absorbent layer has a projected area as determined by a Topography Analysis Method, and the upper surface of the first three dimensionally patterned stabilized absorbent layer has a vertical area as determined by the Topography Analysis Method of at least about 0.1 cm² per 1.0 cm² projected area of the first three dimensionally patterned stabilized absorbent layer.

In another embodiment, the upper surface of the first three dimensionally patterned stabilized absorbent layer has a contact perimeter under load as determined by the Topography Analysis Method of at least about 1.0 cm per 1.0 cm² projected area of the first three dimensionally patterned stabilized absorbent layer.

In yet another embodiment, the upper surface of the first three dimensionally patterned stabilized absorbent layer has an open space under load as determined by the Topography Analysis Method of at least about 0.3 cm³ per 1.0 cm² projected area of the first three dimensionally patterned stabilized absorbent layer.

The second absorbent may be any suitable absorbent and can include a mixture of cellulosic fibers, e.g., a mixture of fluff fibers. The second absorbent may also contain fibers that are treated with a non-fugitive densification agent. As used in the following specification and appended claims, the phrase “non-fugitive densification agent” refers to any agent that has a volatility less than water and/or that forms a hydrogen bond with the fibers or has an affinity for the fibers and provides an ability to decrease the force required to density the fibrous mass or absorbent containing the fibers.

The first absorbent and the second absorbent may both contain a superabsorbent or only one of the first absorbent or second absorbent may contain a superabsorbent.

Unless otherwise specifically noted, all percentages referred to in the following specification and appended claims refer to a percent by weight.

The general object of this invention is to provide an absorbent article that has an absorbent core constructed from two or more layers of material for containing body fluid expelled from a human body. Another object of the invention is to provide an absorbent core that better resists deformation and maintains its integrity and shape in use.

A further object of this invention is to provide an absorbent article that uses an absorbent core formed from two or more layers of material, at least one of which is a three dimensionally patterned stabilized absorbent layer. Accordingly, the article provides improved rewet and intake performance for absorbing bodily exudates such as urine and menses.

Other objects and advantages of the present invention will become more apparent to those skilled in the art in view of the following description and the accompanying drawings

### BRIEF DESCRIPTION OF THE DRAWINGS

FIG. 1 is a top view of an exemplary absorbent article such as a thin incontinence pad or a pantyliner designed to absorb and retain bodily exudates such as urine and/or menses containing an absorbent core according to the present invention.

FIG. 2 is a cross-sectional view of the exemplary absorbent article shown in FIG. 1 taken along line 2-2.

FIG. 3 is a greatly enlarged view of the first three dimensionally patterned stabilized absorbent layer.

FIG. 4 is a cross-sectional view of one embodiment of the absorbent core according to the present invention.

FIG. 5 is a cross sectional view of another embodiment of the absorbent core according to the present invention.

FIG. 6 is a cross-sectional view of one embodiment of a first three dimensionally patterned stabilized absorbent layer taken in the plane of line 2-2 of FIG. 1.

FIG. 7 is a fragmented top plan of the first three dimensionally patterned stabilized absorbent layer of FIG. 6 illustrating a three-dimensional topography of an upper surface of the first three dimensionally patterned stabilized absorbent layer.

FIG. 8 is view similar to FIG. 7 illustrating a second embodiment of a three-dimensional topography of the upper surface of the first three dimensionally patterned stabilized absorbent layer.

FIG. 9 is view similar to FIG. 7 illustrating a third embodiment of a three-dimensional topography of the upper surface of the first three dimensionally patterned stabilized absorbent layer.

FIG. 10 is view similar to FIG. 7 illustrating a fourth embodiment of a three-dimensional topography of the upper surface of the first three dimensionally patterned stabilized absorbent layer.

FIG. 11 is view similar to FIG. 7 illustrating a fifth embodiment of a three-dimensional topography of the upper surface of the first three dimensionally patterned stabilized absorbent layer.

FIG. 12 is a schematic cross-section of the first three dimensionally patterned stabilized absorbent layer of FIG. 6.

FIG. 13 is a schematic perspective of one type of triangle used to mathematically depict a portion of a first three dimensionally patterned stabilized absorbent layer of the present invention.

FIG. 14 is a schematic perspective of a second type of triangle used to mathematically depict a portion of a first three dimensionally patterned stabilized absorbent layer of the present invention.

FIG. 15 is a schematic perspective of a third type of triangle used to mathematically depict a portion of a first three dimensionally patterned stabilized absorbent layer of the present invention.

FIG. 16 is a schematic perspective of a fourth type of triangle used to mathematically depict a portion of a first three dimensionally patterned stabilized absorbent layer of the present invention.

FIG. 17 is a fragmented schematic top plan of opposed mold surfaces used for forming a first three dimensionally patterned stabilized absorbent layer in accordance with one embodiment of a method of the present invention.

FIG. 18 is a fragmented, enlarged schematic section of the opposed mold surfaces of FIG. 17.

FIGS. 19A and 19B are respectively upper and lower mold plates having mold surfaces for imparting a three-dimensional topography to upper and lower surfaces of a first three dimensionally patterned stabilized absorbent layer of the present invention.

FIGS. 20A and 20B are a second embodiment of respective upper and lower mold plates having mold surfaces for imparting a three-dimensional topography to upper and lower surfaces of a first three dimensionally patterned stabilized absorbent layer of the present invention.

FIGS. 21A and 21B are a third embodiment of respective upper and lower mold plates having mold surfaces for imparting a three-dimensional topography to upper and lower surfaces of a first three dimensionally patterned stabilized absorbent layer of the present invention.

FIGS. 22A and 22B are a fourth embodiment of respective upper and lower mold plates having mold surfaces for imparting a three-dimensional topography to upper and lower surfaces of a first three dimensionally patterned stabilized absorbent layer of the present invention.

FIG. 23A is a perspective view of one side of one embodiment of the first three dimensionally patterned stabilized absorbent layer according to the present invention. The texturing is in the general shape of a plurality of circles.

FIG. 23B is a perspective view of another side of the first three dimensionally patterned stabilized absorbent layer of FIG. 23A.

FIG. 24 is a perspective view of one side of another embodiment of the first three dimensionally patterned stabilized absorbent layer according to the present invention. The texturing is substantially isotropic (i.e., has the same general shape on both sides) and is in the general shape of a plurality of squares.

FIG. 25A is a perspective view of one side of another embodiment of the first three dimensionally patterned stabilized absorbent layer according to the present invention. The texturing is in the general shape of curved channels with cones facing upward (or out of the major surface of the layer).

FIG. 25B is a perspective view of another side of the embodiment shown in FIG. 25A. The texturing is in the general shape of curved channels with cones facing downward (or into the major surface of the layer).

FIG. 26A is a perspective view of one side of another embodiment of the first three dimensionally patterned stabilized absorbent layer according to the present invention. The texturing is in the general shape of a channel with a hexagon protruding outward (i.e., away from the major surface of the layer).

FIG. 26B is a perspective view of another side of the first three dimensionally patterned stabilized absorbent layer of FIG. 26A.

FIG. 27 is a perspective view of one side of another embodiment of the first three dimensionally patterned stabilized absorbent layer according to the present invention. The texturing is in the general shape of a plurality of larger squares protruding from the major surface of the layer.

FIG. 28 is a fragmented side elevation of a pair of rolls having opposed mold surfaces formed thereon.

FIG. 29 is a schematic of opposed mold surfaces intermeshed with each other to one-half of the full penetration depth thereof.

FIG. 30 is plan view of an apparatus that can be used to make the second absorbent layer.

FIG. 31 is a top plan of a sample holder used for holding a first three dimensionally patterned stabilized absorbent layer sample in a scanning device.

FIG. 32 is a side elevation of the sample holder shown in FIG. 31.

FIG. 33 is a vertical cross-section of a rate block for conducting a Menses Simulant Intake and Rewet Test, which is described below.

FIG. 34 is a top plan view of the rate block of FIG. 33.

FIG. 35 is a schematic side elevation of a rewet stand that is useful in conducting a Menses Simulant Intake and Rewet Test, which is described below.

FIG. 36 is a top plan view of the rewet stand of FIG. 35.

FIG. 37 is a table of data obtained from conducting a Topography Analysis Method on various first three dimensionally patterned stabilized absorbent layers formed in accordance with the present invention.

FIG. 38 is a table of data obtained from conducting an Intake and Rewet Test on various first three dimensionally patterned stabilized absorbent layers formed in accordance with the present invention.

FIG. 39 is an illustration of the equipment used to determine the liquid saturated retention capacity of an absorbent structure.

Corresponding reference characters indicate corresponding parts throughout the drawings.

### DESCRIPTION OF THE INVENTION

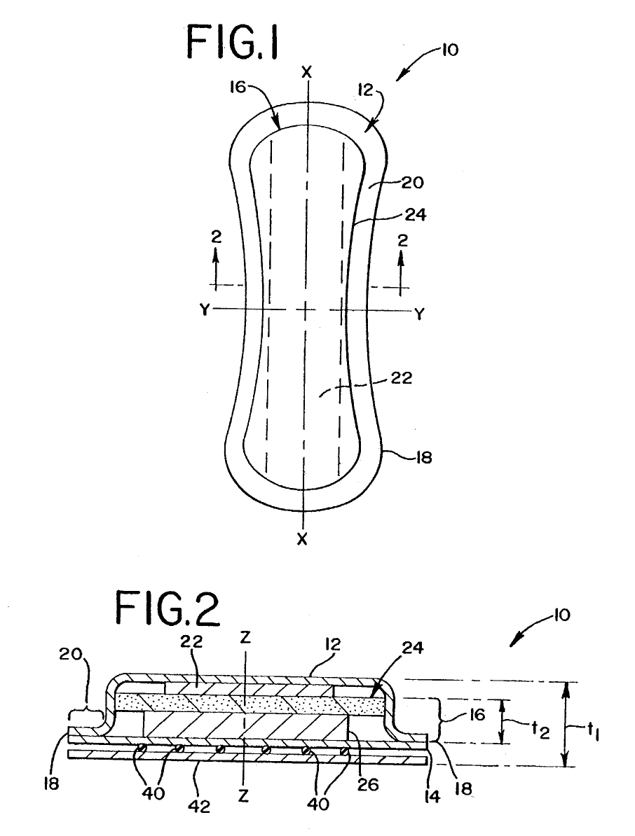

Referring now to the drawings and initially to FIGS. 1 and 2, an absorbent article 10 is shown which is depicted as an incontinence pad or pantyliner. The absorbent article 10 is designed to be secured to an inside surface of a person's undergarment by a garment adhesive and is designed to absorb and retain urine that is involuntarily expelled from the body. The absorbent article 10 is an elongated product having a central longitudinal axis x-x and a central transverse axis y-y. The absorbent article also has a vertical axis z-z, as shown in FIG. 2. Alternatively, for absorbent articles that are more garment-like than pads, such as diapers, children's training pants, and adult incontinence pants, the article can be pulled on like normal underwear or placed on the body and then secured with fasteners such as tape and hook and loop material commonly used for disposable diapers.

The absorbent article 10 includes a liquid permeable liner or cover 12, a liquid-impermeable baffle 14, and an absorbent core 16 positioned and enclosed between the liner 12 and the baffle 14.

The bodyside liner 12 is designed to be in contact with the wearer's body. The bodyside liner 12 can be constructed of a woven, perforated film, or nonwoven material that is easily penetrated by body fluid, especially urine or menses. The liner 12 can also be formed from either natural or synthetic fibers. Suitable materials include bonded-carded webs of polyester, polypropylene, polyethylene, nylon or other heat-bondable fibers. Other polyolefins, such as copolymers of polypropylene and polyethylene, linear low-density polyethylene, finely perforated film webs and net materials, also work well. A suitable material is a soft, wettable polypropylene homopolymer spunbond having a basis weight of from between about 13 grams per square meter (gsm) to about 27 gsm. Another suitable material is an apertured thermoplastic film. Still another material for the bodyside liner 12 is a spunbond web of bicomponent polypropylene/polyethylene side by side or in a sheath/core configuration. The spunbond web can contain from between about one percent (1%) to about six percent (6%) of titanium dioxide pigment to give it a clean, white appearance. A desirable polypropylene web has a basis weight of from between about 13 to about 40 grams per square meter (gsm). An optimum basis weight is from between about 15 gsm to about 25 gsm. The thickness of the bodyside liner 12 can range from between 0.1 mm to about 1.0 mm. An acceptable material is a 17 gsm (0.5 ounces per square yard) surfactant-treated spunbonded polypropylene material supplied by Kimberly-Clark Corporation with offices located in Roswell, Ga.

It should be noted the bodyside liner 12 could be coated, sprayed or otherwise treated with a surfactant to make it hydrophilic. By “hydrophilic” it is meant that the bodyside liner 12 will have a strong affinity for water and a contact angle of less than 90 degrees. The body side liner 12 may also be inherently hydrophilic. When the bodyside liner 12 is formed from a hydrophilic material, it will allow the body fluid to pass quickly therethrough. The bodyside liner 12 can also be embossed to improve the aesthetic appearance of the absorbent article 10.

The liquid permeable liner 12 and the liquid-impermeable baffle (or backsheet) 14 cooperate to enclose and retain the absorbent core 16. The liner 12 and the baffle 14 can be cut, sized, and shaped to have a coterminous outer edge 18. When this is done, the liner 12 and the baffle 14 can be bonded in face to face contact to form an absorbent article 10 having a peripheral seal or fringe 20. The peripheral fringe can be formed to have a width of about 5 millimeters.

The liner 12 and the baffle 14 can have any suitable shape. In general, however, each will have a shape generally in the form of a dogbone, hourglass, t-shape, or racetrack configuration. With a dog bone or hourglass configuration, the absorbent article 10 will have a narrow section located adjacent to the central transverse axis y-y that separates a pair of larger, end lobes. The end lobes can be sized and/or shaped differently, if desired. An absorbent article 10 having a dogbone or hourglass shape is more comfortable to wear than a generally rectangular shaped product. The absorbent article 10 can also be asymmetrical. The liner 12 and the baffle 14 can be bonded or sealed together about their periphery by a construction adhesive to form a unitary absorbent article 10. Alternatively, the liner 12 and the baffle 14 can be bonded together by heat, pressure, by a combination of heat and pressure, by ultrasonics, or other means to form a secure attachment.

The liquid-impermeable baffle 14 can be designed to permit the passage of air or vapor out of the absorbent article 10 while blocking the passage of body fluid, such as urine. The baffle 14 can be made from any material exhibiting these properties. The baffle 14 can also be constructed from a material that will block the passage of vapor as well as fluids, if desired. A good material for the baffle 14 is a micro-embossed, polymeric film, such as polyethylene or polypropylene. Bicomponent films can also be used. A suitable material is polyethylene film. The baffle 14 can also be formed as a laminate of film and a nonwoven such as a spunbond. In a particular embodiment, the baffle 14 will be comprised of a polyethylene film having a thickness in the range of from between about 0.1 mm to about 1.0 mm. The baffle 14 may be about 150 mm to about 320 mm long, and about 60 mm to about 120 mm wide. It is to be understood, however, that for garment-like products such as diapers, pull-on pants, adult briefs, bed pads and the like, the baffle 14 will have a size suitable to meet the needs of the product.

It is also possible to incorporate a surge layer 22. The purpose of a surge layer is to quickly take up and temporarily hold the urine until the absorbent core 16 has adequate time to absorb the urine. The surge layer can be formed from various materials. Two good materials from which the surge layer can be formed include a crimped bicomponent spunbond or from a bonded carded web. When a surge layer is used, it should be designed to have a basis weight from between about 20 gsm to about 120 gsm and a thickness ranging from between about 0.1 mm to about 5 mm. The following U.S. Patents teach surge layers: U.S. Pat. Nos. 5,364,382; 5,429,629; 5,486,166; and 5,490,846, the relevant portions of which are incorporated herein by reference.

Referring to FIG. 2, the absorbent article 10 has an absorbent core 16 that is positioned between the surge layer 22 and the liquid-impermeable baffle 14. If no surge layer 22 is present, the absorbent core 16 is positioned between the bodyside liner 12 and the liquid-impermeable baffle 14. The absorbent core 16 includes a first three dimensionally patterned stabilized absorbent layer 24 and a second absorbent layer 26.

In one embodiment, as shown in FIG. 2, the first three dimensionally patterned stabilized absorbent layer 24 is arranged close to the liner 12 and is positioned vertically above the second absorbent layer 26. For purposes of definition and orientation, the liner 12 is depicted in FIG. 2 as the “top” of the absorbent article 10 and the other components such as the first three dimensionally patterned stabilized absorbent layer 24, the second absorbent layer 26, and the baffle 14 are positioned vertically “below” the liner 12. The first three dimensionally patterned stabilized absorbent layer 24 may be in direct face to face contact with the second absorbent layer 26. In this regard, the first three dimensionally patterned stabilized absorbent layer 24 can be adhered, for example, by an adhesive, to the second absorbent layer 26 to ensure intimate contact and better fluid transfer between them.

Even though the first three dimensionally patterned stabilized absorbent layer 24 and the second absorbent layer 26, may be in direct contact with one another, it is possible to place one or more layers of tissue or fabric between them. Some manufacturers like to wrap an absorbent containing superabsorbent particles to prevent the superabsorbent particles from escaping from the finished product. Accordingly, the first three dimensionally patterned stabilized absorbent layer 24 and/or the second absorbent layer 26 may be wrapped in tissue or a fabric wrap such as a low basis weight spunbond/meltblown or spunbond/meltblown/spunbond composite.

Referring again to FIG. 1, the first three dimensionally patterned stabilized absorbent layer 24 is depicted as having a shaped periphery in the form of a dog bone configuration. Other shapes, such as a rectangle, an hourglass shape, an oval shape, a trapezoid shape, or an asymmetrical shape formed about the longitudinal axis, etc. can also be used. A peripheral shape, wherein the first three dimensionally patterned stabilized absorbent layer 24 is narrowest in the middle along the central transverse axis y-y, works well for it will be more comfortable to wear. A trapezoidal or tapered configuration works well for a male incontinence product.

The first three dimensionally patterned stabilized absorbent layer 24 is a stabilized layer that can include absorbent fibers and may contain a superabsorbent material. As used herein, the term “stabilized absorbent” refers to an absorbent structure or layer that includes binder agents or other materials added to a mixture of other absorbent materials, such as wood pulp fluff and superabsorbent material, when included, to provide an absorbent matrix that has a dry tensile strength of about 6 Newtons/50 mm or more and a wet tensile strength of about 2 Newtons/50 mm or more. It should be noted that the binder agents may be homogeneously added to the absorbent mixture, or they may be added to the absorbent mixture in a stratified configuration. The binder agents are then activated to bond the resultant absorbent matrix together in both a dry and a wet state.

Some stabilized absorbent materials such as foams, wetlaids with wet strength agents, and coform (produced by Kimberly-Clark Corp. with offices in Roswell, Ga.) do not require a separate activation process to achieve the necessary tensile strength. Accordingly, the first three dimensionally patterned stabilized absorbent layer 24 may be constructed of any number of absorbent materials as are well known in the art. For example, the first three dimensionally patterned stabilized absorbent layer 24 may be provided by a layer of “airlaid”, coform, meltblown fibers, bonded carded webs, tissue laminates, absorbent films, foams, a surge/airlaid composite and the like or combinations thereof. Examples of coform materials that may be useful as the first three dimensionally patterned stabilized absorbent layer 24 are described in U.S. Pats. Nos. 4,100,324 and 4,604,313, the relevant portions of which are incorporated herein by reference. Examples of foams that may be useful as the first three dimensionally patterned stabilized absorbent layer 24 are described in U.S. Pats. Nos. 4,540,717 and 5,692,939, the relevant portions of which are incorporated herein by reference. The first three dimensionally patterned stabilized absorbent layer 24 can also be provided by a stabilized wet laid material as described in PCT WO98/51251 with superabsorbent or without superabsorbent, as described in PCT WO 98/24392, the relevant portions of both are incorporated herein by reference.

In one embodiment, the first three dimensionally patterned stabilized absorbent layer 24 may be provided as an airlaid pledget that can be a combination of hydrophilic fibers, high absorbency material, and binder material. As used herein, the term “airlaid” refers to the process of producing an absorbent material where unlike components are conveyed in an air-stream and homogenously mixed or provided in a stratified configuration and then bonded together. For example, this may include, but is not limited to, the mixture of pulp fibers, synthetic fibers, superabsorbent materials and binder material. The binder material is often, but not limited to, synthetic bicomponent binder fibers and/or latexes. There are a number of commercial processes available to produce airlaid absorbent structures. For example, airlaid processes are available from Danweb Corp. having offices in Risskov, Denmark, and from M&J Forming Technologies having offices in Horsens, Denmark. Examples of suitable products and the process for forming them are described in U.S. Pat. No. 4,640,810, U.S. Pat. No. 4,494,278, U.S. Pat. No. 4,351,793, and U.S. Pat. No. 4,264,289, the relevant portions of which are incorporated by reference.

An airlaid process provides a mixture of raw materials and the ability to add synthetic fibers and/or binder agents to the mixture to stabilize the resultant absorbent. As a stabilizer, binders reduce the amount of wet collapse in the structure and maintain a lower density in the saturated state. That is, the binder assists the absorbent matrix in maintaining its integrity even under load or while saturated. In addition, the resulting structure has both a higher dry and wet tensile strength than a corresponding structure without a binding agent.

Various types of wettable, hydrophilic fibrous material can be used to provide the fiber material for the first three dimensionally patterned stabilized absorbent 24. Examples of suitable fibers include naturally occurring organic fibers composed of intrinsically wettable material, such as cellulosic fibers; manmade fibers composed of cellulose or cellulose derivatives, such as rayon fibers; inorganic fibers composed of an inherently wettable material, such as glass fibers; synthetic fibers made from inherently wettable thermoplastic polymers, such as particular polyester or polyamide fibers; and synthetic fibers composed of a nonwettable thermoplastic polymer, such as polypropylene fibers, which have been hydrophilized by appropriate means. The fibers may be hydrophilized, for example, by treatment with silica, treatment with a material that has a suitable hydrophilic moiety and preferably is not readily removable from the fiber, or by sheathing the nonwettable, hydrophobic fiber with a hydrophilic polymer during or after the formation of the fiber. For the purposes of the present invention, it is contemplated that selected blends of the various types of fibers mentioned above may also be used.

In a particular aspect where the wettable, hydrophilic fibrous material is a cellulosic fiber, the cellulosic fiber may be produced by a number of processes as are well known in the art. For example, cellulosic fibers may be made by wood pulping processes that include, but are not limited to Kraft, sulphite, chemi-thermomechanical pulping (CTMP), thermomechanical pulping (TMP), or groundwood pulping. In addition, cellulosic fibers may also be bleached using suitable bleaching techniques. Sources of cellulosic fibers as described above may include, but are not limited to softwoods, hardwoods, flax, straw, and other organic materials, and combinations thereof.

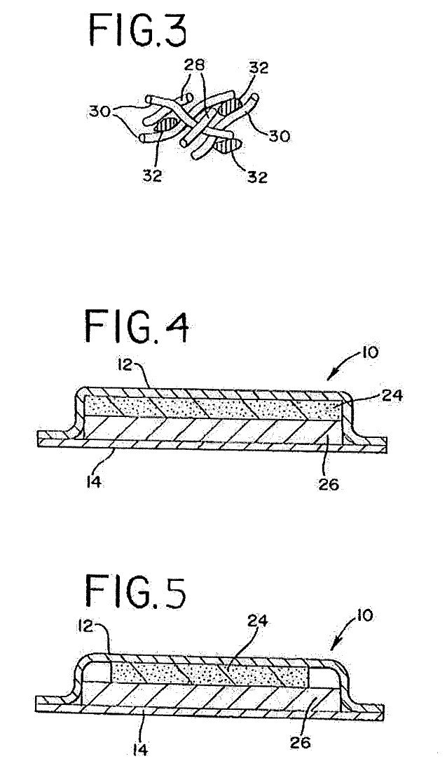

Referring to FIG. 3, the first three dimensionally patterned stabilized absorbent layer 24 is shown as a blend of a first group of fibers 28, a binder 30 in the form of a second group of fibers, and the optional superabsorbent 32, which is cured to form a stabilized, airlaid absorbent structure to which texturing can be imparted, as will be explained in more detail below. The first group of fibers 28 can be cellulosic fibers, such as pulp fibers, that are short in length, have a high denier, and are hydrophilic. The first group of fibers 28 can be formed from 100% softwood fibers. Desirably, the first group of fibers 28 is southern pine Kraft pulp fibers. A suitable material to use for the first group of fibers 28 is Weyerhaeuser NB 416 pulp fibers, which is commercially available from Weyerhaeuser Company, Federal Way, Wash. Alternatively the first group of fibers can be manmade or synthetic fibers as previously described or the first group of fibers 28 may be a combination of these materials.

The binder portion of the first three dimensionally patterned stabilized absorbent layer 24 can be a chemical coating or a wet adhesive application such as latex that may be sprayed, foamed, or layered on the first absorbent.

Stabilization of the first three dimensionally patterned stabilized absorbent layer 24 may also be achieved by use of emulsion binders. Physical strength can also be imparted by the use of a class of materials described herein as “latex binders.” Examples of such latex binders include, but are not limited to, emulsion polymers such as thermoplastic vinyl acetate, C₁-C₈ alkyl ester of acrylic, methacrylic acid based adhesive, and combinations thereof. In particular, the emulsion polymerized thermoplastic adhesive can have a glass transition temperature (Tg) from −25° C. to 20° C., a solids content of from 45% to 60% by weight, typically from 52% to 57%, and a Brookfield viscosity (#4 spindle, 60 rpm at 20° C.) of from 5 to 1000 centipoises (cps). Preferred adhesives are vinyl acetate/ethylene based adhesives incorporating less than about 10% and preferably less than 5% by weight, of a polymerized third monomer. Representative examples of third monomers which may be incorporated into the polymer include adhesion promoting monomers such as unsaturated carboxylic acid including acrylic and methacrylic acid, crotonic acid, and epoxide containing monomers such as glycidyl acrylate, glycidylmethacrylate and the like. The Airflex 401, 405 and 410 are some examples. These binders can be obtained from Air Products and Chemicals Inc. located in Allentown, Pa. In addition, cross linkable binders (thermoset) may be used to impart further wet strength thereto. The thermoset vinyl acetate/ethylene binders, such as vinyl acetate/ethylene having from 1-3% N-methylolacrylamide such as Airflex 124, 108 or 192, available from Air Products and Chemicals Inc. located in Allentown, Pa., or Elite 22 and Elite 33, available from National Starch & Chemicals, located in Bridgeport, N.J., are examples of suitable adhesive binders.

To obtain a stabilized structure, emulsion polymerized thermoplastic polymeric adhesive is applied to an un-stabilized fluff/superabsorbent structure in an amount ranging from 1 to 20 grams dry adhesive per square meter of substrate. In particular aspects, 5 to 15 grams of dry adhesive per square meter of substrate where the dry adhesive is applied by a spray method may provide suitable bonds.

Non-liquid binder material may also be used as a stabilizing agent. For example, binder powders may be used to stabilize absorbent structures. Binder powders for use in absorbent structures are available under the trade name VINNEX available from Wacker Polymer Systems L.P., having offices in Adrian, Mich. Alternatively, thermally activated binder material, such as thermally activated binder fiber material, may be used to stabilize absorbent structures. Binder fibers are typically used in airlaid absorbent structures for higher basis weight absorbent structures, that is, greater than 70 gsm. Binder fibers generally have two components and are therefore termed bi-component fibers. The two components may include a sheath and a core. Other suitable binder fiber configurations include side by side, islands in the sea, and thermoplastic staple fibers.

Desirably, the binder portion of the first three dimensionally patterned stabilized absorbent 24 will consist of a second group of fibers 30. The second group of fibers 30 can be synthetic binder fibers. Synthetic binder fibers are commercially available from several suppliers. One such fiber is TREVIRA 255 2.2 decitex 3 mm Lot 1663 supplied by Trevira GmbH & Company KG having a mailing address of Max-Fischer-Strasse 11, 86397 Bobingen, Germany. Another supplier of binder fibers is Fibervisions a/s having a mailing address of Engdraget 22, Dk-6800 Varde, Denmark. A third supplier of binder fibers is KoSa having a mailing address of P.O. Box 4, Highway 70 West, Salisbury, N.C. 28145. Yet another suitable supplier is Chisso Corporation, having offices in Tokyo, Japan.

Desirably, the second group of fibers 30 is bicomponent fibers having a polyester core surrounded by a polyethylene sheath. Alternatively, the second group of fibers 30 can be bicomponent fibers having a polypropylene core surrounded by a polyethylene sheath. The polyethylene sheath may be high density, low density, or linear low density polyethylene and may have an activating agent such as maleic anhydride incorporated into the polymer.

The fibers making up the second group of fibers 30 can be longer in length and have a lower denier than the fibers making up the first group of fibers 28. The length of the fibers 30 can range from between about 3 mm to about 6 mm or more. A fiber length of 6 mm works well. The fibers 30 can have a denier of less than or equal to 2.0. The fibers 30 should be moisture insensitive and can be either crimped or non-crimped. Crimped fibers are preferred since they usually process better than non-crimped fibers.

It is also possible to make hybrid airlaid structures that use both latex and adhesive means of bonding combined with the use of thermally activated binder fibers.

As noted above, the first three dimensionally patterned stabilized absorbent layer 24 may contain a superabsorbent 32. A superabsorbent is a material that is capable of absorbing at least 10 grams of water per gram of superabsorbent material. The superabsorbent 32 is preferably in the shape of small particles, although fibers, flakes or other forms of superabsorbents can also be used. A suitable superabsorbent 32 is FAVOR SXM 880. FAVOR SXM 880 is commercially available from Stockhausen, Inc., having an office located at 2408 Doyle Street Greensboro, N.C. 27406. Other similar types of superabsorbents, such as FAVOR SXM 9543 and FAVOR SXM 9145, which are commercially available from Stockhausen, can be used.

The superabsorbent 32 is present in the first three dimensionally patterned stabilized absorbent layer 24 in a weight percent of from between about 0% to about 85%. The amount of superabsorbent 32 present in the first three dimensionally patterned stabilized absorbent layer 24 depends on the composition of the second absorbent layer 26 and the ultimate function of the absorbent article 10.

The individual components 28, 30, and 32 of the first three dimensionally patterned stabilized absorbent layer 24 can be present in varying amounts. It has been found, however, that the following percentages work well in forming the absorbent article 10. The first group of fibers 28 can range from between about 30% to about 95% by weight, of the first absorbent 24. The second group of fibers 30 can range from between about 5% to about 40% by weight, of the first absorbent 24. The superabsorbent 32 can range from between about 0% to about 85% by weight, of the first absorbent 24. It has been found that forming a first absorbent 24 with about 50% to about 95% of the first group of fibers 28, about 5% to about 20% of the second group of fibers 30, and about 0% to about 40% of superabsorbent works well for absorbing and retaining urine.

The first group of fibers 28 should be present in the first absorbent 24 by a greater percent, by weight, than the second group of fibers 30. By using a greater percent of the first group of fibers 28 the overall cost of the first absorbent 24 can be reduced. The first group of fibers 28 also ensures that the absorbent article 10 has sufficient fluid absorbing capacity. Cellulosic fibers 28, such as pulp fibers, are generally less expensive than synthetic binder fibers 30. For good performance, the second group of fibers 30 should make up at least about 4% by weight of the first three dimensionally patterned stabilized absorbent layer 24 to ensure that the first three dimensionally patterned stabilized absorbent layer 24 has sufficient tensile strength in both a dry and wet state.

By providing a stabilized material with sufficient tensile strength, the stabilized material can be wound into rolls that can later be unwound and processed on converting equipment. In addition, sufficient tensile strength in a dry and wet state helps the absorbent article 10 to resist deformation and to increase its integrity during use. Sufficient tensile strength can be achieved by varying the content of the binder fiber or binder fiber components, adjusting the curing conditions, changing the specific density to which the fibers are compacted, as well as other ways known to one skilled in the art. It has been found that the first three dimensionally patterned stabilized absorbent 24 should have a dry tensile strength of at least about 6 Newtons per 50 mm (N/50 mm). The first three dimensionally patterned stabilized absorbent 24 may however have a dry tensile strength of at least about 18 N/50 mm.

In addition, it has been found that the contribution that the binder fibers provide to the compression modulus and to the compression resilience is enhanced, when the three dimensional pattern is provided. Homogeneously adding binder fibers will increase the wet and dry tensile strength of the material. Moreover, adding binder fiber in an amount greater than about 5% tends to reduce the wet collapse and to increase the wet resilience of the absorbent layer. When these layers are further processed to have a surface topography such that parts of the layer are partially oriented perpendicular to the layer, then the wet resilience is increased further. These physical enhancements provide the layer with improved performance characteristics.

The tensile strength of the material can be tested using a tester such as a Model 4201 Instron with Microcon II from Instron Corp. Canton, Mass. The machine is calibrated by placing a 100 gram weight in the center of the upper jaw, perpendicular to the jaw and hanging unobstructed. The tension cell used is a 5 kilogram electrically-calibrating self-identifying load cell. The weight is then displayed on the Microcon display window. The procedure is performed in a room with standard-condition atmosphere such as about a temperature of about 23° C. and a relative humidity of about 50 percent.

A rectangular sample 5 cm by 15 cm is prepared. The dry sample is then placed in the pneumatic action grips (jaws) with 1 inch (2.54 cm) by 3 inch (7.62 cm) rubber coated grip faces. The gauge length is 10 cm and the crosshead speed is 250 mm/minute. The crosshead speed is the rate at which the upper jaw moves upward pulling the sample until failure. The Tensile Strength value is the maximum load at failure, recorded in grams of force needed to permanently stretch or tear the sample. The tensile strength is evaluated for the material in both a dry condition and a 100 percent liquid saturated condition. The tensile strength for the material in a 100 percent liquid saturated condition is done by placing a dry sample in a container containing a sufficient excess of 0.9% saline solution for 20 minutes, after which the sample is placed in the jaws and the tensile strength is measured as described above.

Desirably, the first three dimensionally patterned stabilized absorbent 24 is a stabilized airlaid absorbent to provide for integrity and tensile strength in the wet state and to improve liquid distribution. The first three dimensionally patterned stabilized absorbent 24 according to the present invention has, in general, a dry strength of at least about 6 N/50 mm and a wet strength of at least about 2 N/50 mm.

An example of such a material is a 100 gsm airlaid structure made by Concert Industries in Gatineau, Quebec comprising 80% by weight Weyerhaeuser NB-416 fibers and 20% by weight KoSa T-255 binder fibers (6 mm, 2 denier) at a density of 0.07 g/cc. This material has a dry tensile strength of about 25 N/50 mm and a wet tensile strength of about 14 N/50 mm.

As noted above, the first three dimensionally patterned stabilized absorbent layer 24 may be provided as a textured web, of which U.S. patent application Publication No. 2003/0036741 is an example. The relevant portions of U.S. patent application Publication No. 2003/0036741 are incorporated herein by reference. Briefly, this publication describes an airlaid fibrous web that includes a repeating pattern of peak areas separated by valley areas.

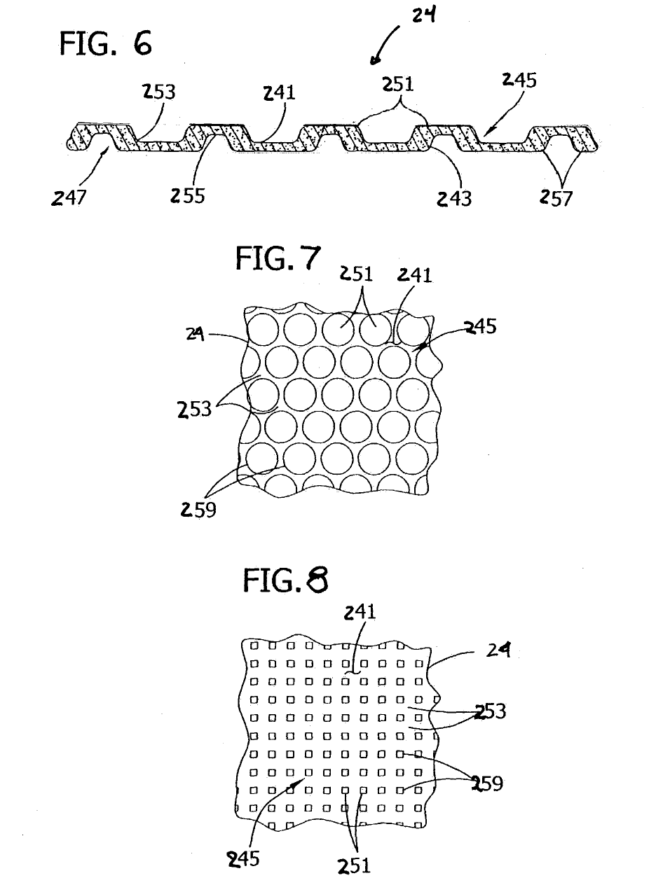

With particular reference to FIG. 6, the first three dimensionally patterned stabilized absorbent layer 24 is formed to have a three dimensional topography on both an upper (e.g., liner facing) surface 241 and a lower (e.g., outer cover facing) surface 243 of the first three dimensionally patterned stabilized absorbent layer. As used herein, the three-dimensional topography is intended to mean that the upper and lower surfaces 241, 243 of the first three dimensionally patterned stabilized absorbent layer 24 each have pronounced, z-direction (e.g., the thickness direction) surface features, generally indicated respectively at 245, 247, projecting inward and/or outward relative in the z-direction relative to the plane defined by the longitudinal and lateral axes of the first three dimensionally patterned stabilized absorbent layer. For example, the three-dimensional topography of the upper surface 241 of the first three dimensionally patterned stabilized absorbent layer 24 shown in FIG. 6 has a plurality of peaks 251 and valleys 253 wherein the height (e.g., z-direction difference) between the peaks and their respective adjacent valleys is greater than that of nominal surface variations resulting from manufacturing tolerances, such as at least about 0.9 mm when the first three dimensionally patterned stabilized absorbent layer 24 is under a load of about 0.05 psi (about 0.345 kPa) as described later herein. The three-dimensional topography of the lower surface 243 of the first three dimensionally patterned stabilized absorbent layer 24 also has a plurality of peaks 255 and valleys 257 having a similar minimum height (e.g., z-direction difference therebetween).

In the illustrated embodiment, the locations of the peaks 251 of the upper surface 241 correspond generally to the locations of respective peaks 255 of the lower surface 243 and the locations of the valleys 253 of the upper surface correspond generally to the locations of respective valleys 257 of the lower surface. However, it is understood that the shapes, height, etc. of the upper surface peaks 251 and valleys 253 need not be identical or otherwise similar to the corresponding lower surface peaks 255 and valleys 257. It is also understood that the locations of the upper surface peaks 251 and valleys 253 need not correspond to the locations of the lower surface peaks 255 and valleys 257 to remain within the scope of this invention, as long as both the upper and lower surfaces 241, 243 of the first three dimensionally patterned stabilized absorbent layer each have a three dimensional topography. Also, the three-dimensional topography of the upper and lower surfaces 241, 243 may extend fully or it may extend only partially across the width and/or along the length of the first three dimensionally patterned stabilized absorbent layer 24.

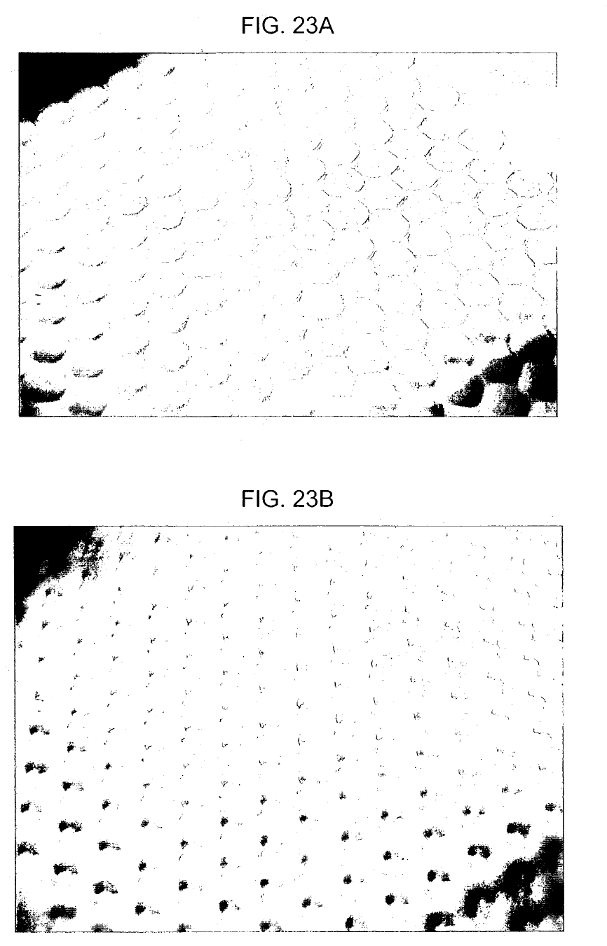

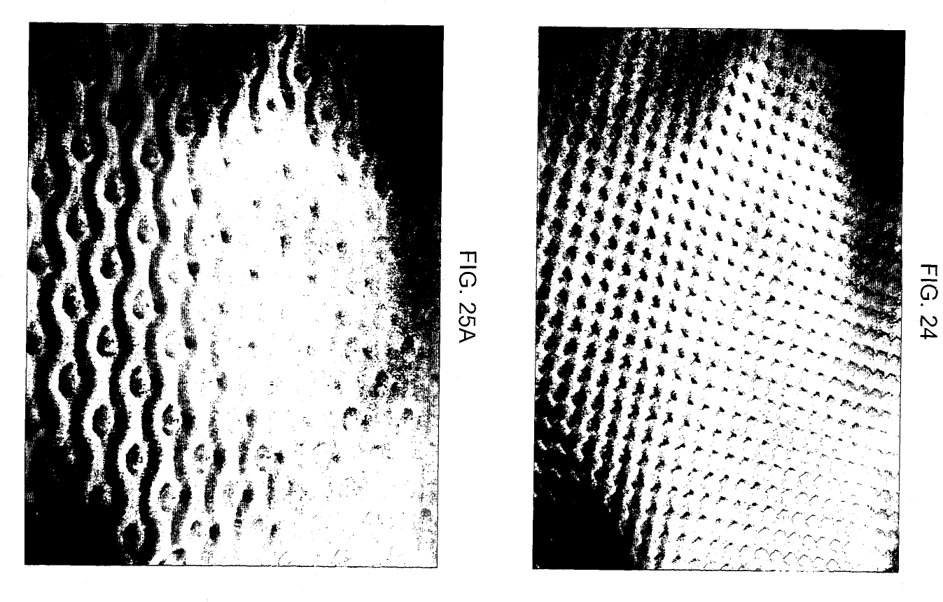

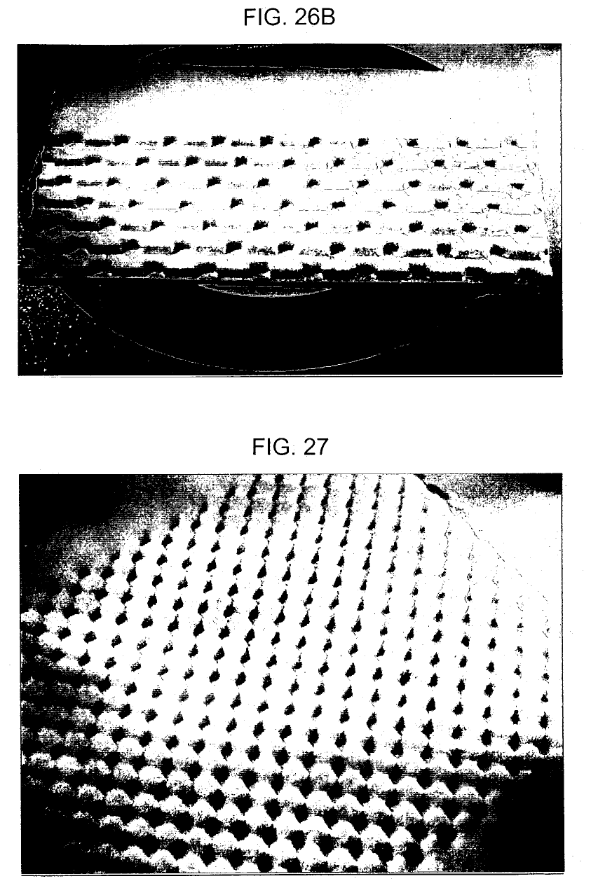

The peaks 251, 255 of the upper and lower surfaces 241, 243 of the first three dimensionally patterned stabilized absorbent layer 24 may be in the form of discrete peaks surrounded by interconnected valleys (e.g., the valleys are generally continuous). As an example, FIGS. 7, 8, 9, 10 illustrate various first three dimensionally patterned stabilized absorbent layers 24 in which the upper surface 241 has a plurality of surface features 245 in the form of discrete bumps 259 defining discrete peaks 251 and generally continuous or otherwise interconnected valleys 253 of the upper surface. Likewise, FIGS. 23A, 23B, 24, 25A, 25B, 26A, 26B, and 27 illustrate certain texturing that can be provided on the first three dimensionally patterned stabilized absorbent layer 24.

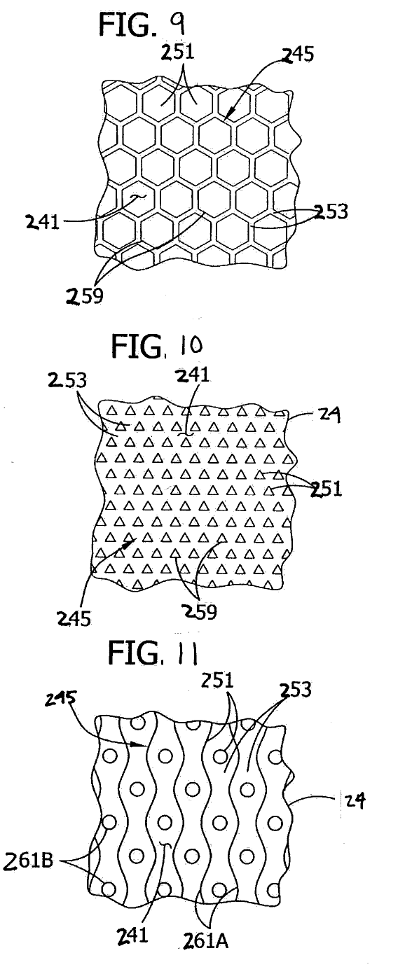

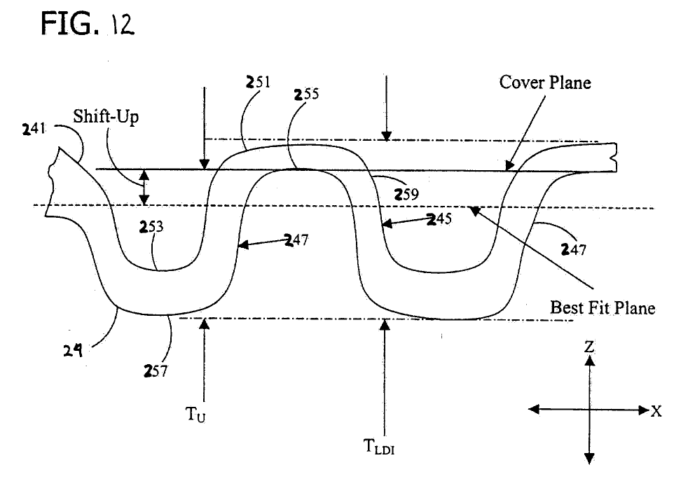

In FIG. 7, the bumps are generally circular in horizontal cross-section; in FIG. 8 the bumps are generally square in horizontal cross-section; in FIG. 9 the bumps are generally hexagonal in horizontal cross-section; and in FIG. 10 the bumps are generally triangular in horizontal cross-section. In another embodiment shown in FIG. 11, the surface features 245 of the upper surface 41 include bumps in the form of ridges 261a extending in a serpentine manner generally continuously along the length of the first three dimensionally patterned stabilized absorbent layer 24. Additional discrete bumps 261b are disposed intermediate the ridges 261a. It is also contemplated that other three-dimensional surface patterns are within the scope of this invention, as long as the upper and lower surfaces 241, 243 of the first three dimensionally patterned stabilized absorbent layer 24 each have a plurality of peaks 251, 255 and valleys 253, 257. For example, the peaks of the upper surface (and/or the lower surface) may be interconnected (e.g., the peaks may be generally continuous) and surrounded by discrete valleys.

Also, the pattern defined by the three-dimensional topographies of the upper surfaces 241 shown in each of 7-11 are generally uniform, repeating patterns both across the width and along the length of the first three dimensionally patterned stabilized absorbent layer 24. However, it is contemplated that the pattern defined by the three-dimensional topography may be non-repeating in one or both of the longitudinal and lateral directions of the first three dimensionally patterned stabilized absorbent layer 24. For example, the size, shape, number, etc. of the surface features 245, 247 may vary along the width and/or length of the first three dimensionally patterned stabilized absorbent layer 24. It is also contemplated that the pattern of surface features 245, 247 on the upper surface 241 and/or lower surface 243 may be generally random.

The height of the surface features 245 on the upper surface 241 of the first three dimensionally patterned stabilized absorbent layer 24, as measured from one peak 251 to an adjacent valley 253 with the first three dimensionally patterned stabilized absorbent layer unloaded, is suitably at least about 1 mm, and more suitably in the range of about 1.5 mm to about 5 mm. The surface features 247 on the lower surface 243 suitably have a height within this range. As an example, the height of the square bumps 259 shown on the upper surface 241 of the first three dimensionally patterned stabilized absorbent layer 24 of FIG. 8 is about 1.4 mm as is the height of the serpentine ridges 261a shown on the upper surface of the first three dimensionally patterned stabilized absorbent layer of FIG. 11.

The surface feature density of the upper surface 241 of the first three dimensionally patterned stabilized absorbent layer 24, e.g., the number of bumps or other surface features 245 per square cm of upper surface, is suitably measured by first evaluating the pattern of surface features to determine a “minimum repeat area” that can be used to recreate the entire upper surface. For the case of unique or otherwise non-repeating patterns that comprise the entire upper surface, the entire upper surface comprises the minimum repeat area. The number of surface features present within the minimum repeat area is divided by the projected area of the minimum repeat area. The term projected area refers to an area corresponding to a flat area (e.g., in the horizontal plane) that would be covered if the first three dimensionally patterned stabilized absorbent layer 24 were laid on a flat surface.

The surface feature density is suitably at least about 0.1 features per square cm of projected area, and is more suitably in the range of about 0.2 to about 10 surface features per square cm of projected area. It is understood, however, that the surface feature height and or density may be other than as set forth above; as long as the surface feature density is at least about 0.1 surface features per square centimeter of projected area.

In one embodiment, the first three dimensionally patterned stabilized absorbent layer 24 has a generally uniform basis weight whereby the basis weight of the first three dimensionally patterned stabilized absorbent layer at the peaks 251 of the upper surface 241 is substantially equal to the basis weight of the first three dimensionally patterned stabilized absorbent layer at the valleys 253 of the upper surface. The term “substantially equal” in reference to the basis weight of the first three dimensionally patterned stabilized absorbent layer 24 at the peaks 251 and valleys 253 of the upper surface 241 is intended to mean that the basis weights are within approximately 10 percent of each other. The average basis weight of the first three dimensionally patterned stabilized absorbent layer 24 is suitably in the range of about 60 grams per square meter (gsm) to about 1500 gsm, and more suitably in the range of about 120 gsm to about 225 gsm. However, it is contemplated that the basis weight of the first three dimensionally patterned stabilized absorbent layer 24 at the peaks 251 of the upper surface 241 may instead be greater than or less than (e.g., by more than about 10 percent) the basis weight of the first three dimensionally patterned stabilized absorbent layer at the valleys 253 of the upper surface.

The density of the first three dimensionally patterned stabilized absorbent layer 24 at the peaks 251 and valleys 253 of the upper surface 241 generally depends on whether the basis weight is substantially uniform and also depends on the relative size and shape of the peaks 251 and valleys 253 of the upper surface compared to the size and shape of the peaks 255 and valleys 257 of the lower surface 243. In general, the density of the first three dimensionally patterned stabilized absorbent layer 24 is suitably in the range of about 0.06 grams per cubic centimeter (g/cc) to about 0.40 g/cc, and more suitably in the range of about 0.10 g/cc to about 0.20 g/cc. The density of the first three dimensionally patterned stabilized absorbent layer 24 at the peaks 251 of the upper surface 241 may be greater than, less than or otherwise about equal to the density of the first three dimensionally patterned stabilized absorbent layer 24 at the valleys 253 of the upper surface.

In another embodiment, the absorbent structure topography is combined with a liner material that has surface topography. The topography of the liner may or may not be similar in design, scale, or orientation to the topography of the absorbent structure. These liner/absorbent structure combinations require alternate methods for calculating open space under load, contact area under load, and contact perimeter under load due to the fact that the cover is not planer. Such modifications to the methods can be made by those skilled in the art. These structures have reduced contact with the user's skin and can therefore further reduce rewet and help maintain skin health.

In another embodiment, the absorbent structure topography is combined with a cover material that has surface topography. The topography of the cover may or may not be similar in design, scale, or orientation to the topography of the absorbent structure. These cover/absorbent structure combinations require alternate methods for calculating open space under load, contact area under load, and contact perimeter under load due to the fact that the cover is not planer. Such modifications to the methods can be made by those skilled in the art. These structures have reduced contact with the user's skin and can therefore further reduce rewet and help maintain skin health.

In accordance with the present invention, the three-dimensional topography of the upper surface 241 of the first three dimensionally patterned stabilized absorbent layer 24 also defines certain characteristics as determined by the Topography Analysis Method set forth below.

Topography Analysis Method

The Topography Analysis Method described herein is a mathematical characterization of the three-dimensional topography of the upper and/or lower surfaces 241, 243 of the first three dimensionally patterned stabilized absorbent layer 24. The method generally utilizes a three dimensional laser scanning of the upper and lower surfaces 241, 243 of the first three dimensionally patterned stabilized absorbent layer 24 to generate a point cloud comprising a plurality of spatial points which accurately depict the topography of the upper and lower surfaces. Scanning is completed on both the upper and lower surfaces so that the relative positions of both surfaces are accurately represented in the point cloud. The spatial points are then used to define a plurality of triangles which map the topography of the upper and lower surfaces 241, 243, wherein each triangle shares two vertices with an adjacent triangle. As an example of the resolution of the data, the triangles suitably have an average side length of about 0.035 cm.

Absorbent structures on which the Topography Analysis Method may be performed are suitably formed to resist substantial collapse under load (e.g., when a load is applied to the upper and/or lower surfaces 241, 243 of the absorbent structure). Collapse refers to a situation in which a portion of a surface feature of the absorbent structure obscures any other portion of the surface feature when under a pressure of 0.05 psi (about 0.345 kPa) and viewed from directly above. The absorbent structures described later herein for which the Topography Analysis Method was performed all satisfy this criterion. However, it is understood that simple modifications to the Topography Analysis Method can be made to account for absorbent structures that collapse under such a load.

The data describing the triangles is stored in at least two different “STL” data files, with one STL data file containing only the data describing the triangles for the upper surface 241 of the scanned first three dimensionally patterned stabilized absorbent layer 24 and another STL data filed containing the data describing the triangles for both the upper and lower surfaces 241, 243 of the first three dimensionally patterned stabilized absorbent layer. It is contemplated that a third STL data filed containing the data describing the triangles for only the lower surface 243 of the first three dimensionally patterned stabilized absorbent layer 24 may also be generated. The triangle vertices are represented in the STL data file in a standard Cartesian coordinate system.

Each STL data file has the following format:

| Size | Format | Description |
|---|---|---|
| 80 bytes | ASCII | File Description Header |
| 4 bytes | Unsigned long integer | Number of triangles in the file |
| 4 bytes | Float | I component of normal vector |
| 4 bytes | Float | J component of normal vector |
| 4 bytes | Float | K component of normal vector |
| 4 bytes | Float | x component of Point 1 vertex |
| 4 bytes | Float | y component of Point 1 vertex |
| 4 bytes | Float | z component of Point 1 vertex |
| 4 bytes | Float | x component of Point 2 vertex |
| 4 bytes | Float | y component of Point 2 vertex |
| 4 bytes | Float | z component of Point 2 vertex |
| 4 bytes | Float | x component of Point 3 vertex |
| 4 bytes | Float | y component of Point 3 vertex |
| 4 bytes | Float | z component of Point 3 vertex |
| 2 bytes | Unsigned integer | Attribute byte count |

The outer surface of the triangle (e.g. the surface of the triangle that faces outward of the first three dimensionally patterned stabilized absorbent layer 24) is defined as that surface of the triangle where the vertices are arranged counterclockwise from point 1 to point 2 to point 3. A mathematically synonymous way to determine the outer surface of the triangle is to define a vector normal to the triangle as the normalized cross product of the vectors point 2—point 1 and point 3—point 1. Adhering to this criterion is mandatory for using the analytical code attached hereto as Appendices A and B and described later herein to analyze the STL data files. The order of the points in the STL data files is used repeatedly to determine the orientation of the triangles. It is also important that the scanning be performed with the first three dimensionally patterned stabilized absorbent layer oriented generally along the X, Y plane whereby the first three dimensionally patterned stabilized absorbent layer thickness is generally aligned with the Z axis. Additionally the user facing surface (upper surface) must be set such that it faces in the positive Z direction. One suitable scanning of first three dimensionally patterned stabilized absorbent layers and generation of corresponding STL data files is commercially performed by Laser Design Incorporated of Minneapolis, Minn., U.S.A.

One analytical code, Whole Analysis 7, is used to read the STL data file for the upper surface 241 of the scanned first three dimensionally patterned stabilized absorbent layer 24 and to mathematically analyze various characteristics of the upper surface. The Whole Analysis 7 code is suitable for use with a software package commercially available from Wolfram Research, Inc. of Champaign, Ill., U.S.A under the trade name Mathematica. The Whole Analysis 7 code (and Get Thickness 7 code described later herein) was generated and processed using Mathematica version 4.2. In particular, with reference to the Whole Analysis 7 code and to FIG. 12, the center of each triangle in the upper surface 241 STL data file is determined and a simple regression fit is used to fit the center points of the triangles to the equation Z=B₀+B₁*X+B₂*Y. This equation defines a plane, referred to in the Whole Analysis 7 code and indicated in FIG. 12 as the “Best Fit Plane,” for the upper surface 241 of the first three dimensionally patterned stabilized absorbent layer 24. Next, a base point is defined on the Best Fit Plane and a vector (referred to in the Whole Analysis 7 code as “PlaneNorm”) normal to the Best Fit Plane (e.g., in the z-direction) is determined. Of the two normal vectors to the best fit plane, the one most closely aligned to the positive Z axis is chosen. The distance from the center of each triangle to the Best Fit Plane is then calculated, with positive distances being in the direction of the normal vector (e.g., PlaneNorm) and negative distances being in the opposite direction of the normal vector.

With further reference to FIG. 12, a “Cover Plane” is also determined for the first three dimensionally patterned stabilized absorbent layer 24. The Cover Plane represents the approximate location and orientation of the bodyside liner 12 (FIG. 2) overlaying the upper surface 241 (e.g. in contact with the peaks 251 thereof) of the absorbent article 10 when the first three dimensionally patterned stabilized absorbent layer is under a 0.05 psi load, otherwise referred to herein as being “under load”.

To determine the Cover Plane, a second analytical code, Get Thickness 7 code, is used to calculate the unloaded apparent, or overall thickness (indicated as T_{LDI} in FIG. 12) of the-first three dimensionally patterned stabilized absorbent layer 24 (e.g., from the valleys 257 of the lower surface 243 of the first three dimensionally patterned stabilized absorbent layer to the peaks 251 of the upper surface 241 of the first three dimensionally patterned stabilized absorbent layer 24). The Whole Analysis 7 code is suitable for use with Mathematica and uses the combined (upper and lower surface 241, 243) STL data file. To determine the overall unloaded thickness of the first three dimensionally patterned stabilized absorbent layer 24, the center of each triangle in the combined STL data file is determined and a simple regression fit is used to fit the center points of the triangles to the equation Z=B₀+B₁*X+B₂*Y. The equation defines a plane, referred to in the Whole Analysis 7 code as the Best Fit Plane (not shown) for the combined upper and lower surfaces 241, 243. One skilled in the art will recognize that the Best Fit Plane for the combined STL data file is not necessarily the same as the Best Fit Plane shown in FIG. 12 for only the upper surface 241 STL data file. Next, a base point is defined on the Best Fit Plane of the combined upper and lower surfaces 241, 243 and a vector normal thereto is determined.

The distance from the center of each triangle to the Best Fit Plane of the combined STL upper and lower surfaces 241, 243 is then calculated, with positive distances being in the direction of the normal vector and negative distances being in the opposite direction of the normal vector. The unloaded thickness (T_{LDI}) is the maximum calculated distance from the center of the triangles of the combined STL data file minus the minimum calculated distance from the center of the triangles of the combined STL data file.

To determine an overall thickness or caliper under load (T_{U}), a bulk tester such as a Digimatic Indicator Gauge, type DF 1050E, which is commercially available from Mitutoyo Corporation of Japan, may be used. The bulk tester includes a flat base and a smooth platen connected to the indicator gauge of the tester. The platen has a diameter of about 3 inches (7.62 cm) and is capable of applying a uniform pressure of about 0.05 psi (0.345 kPa) over a 3 inch (7.62 cm) diameter portion of the first three dimensionally patterned stabilized absorbent layer 24. A 4 inch by 4 inch (10.16 cm by 10.16 cm) sample of the scanned first three dimensionally patterned stabilized absorbent layer 24 is placed on the base and the platen pressure is applied centrally of the sample such that no part of the platen overhangs the sample. Caliper measurements of the overall thickness under load are made in a room that is about 23° C. and at about 50% relative humidity. Materials that are less than 4 inch by 4 inch (10.16 cm by 10.16 cm) can be evaluated using the same technique, but require a platen that is smaller in area than the material being tested, and has a mass that will exert a pressure of 0.05 psi (0.345 kPa) to the material.

A new base point is then determined by shifting the base point up by an amount (indicated in FIG. 12 as “Shift Up”) equal to Tₘₐₓ−(T_{LDI}−T_{U}), where Tₘₐₓ is the calculated distance between the Best Fit Plane (for the upper surface 241) and the center of the triangle spaced furthest from that Best Fit Plane in the direction of the normal vector. The new base point and the normal vector (which is normal to both the Best Fit Plane and the Cover Plane) together define the Cover Plane.

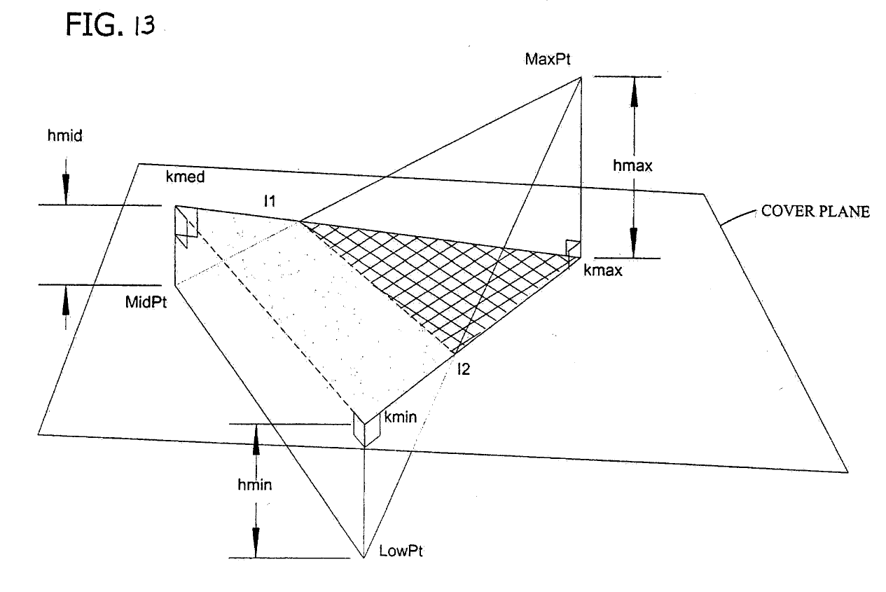

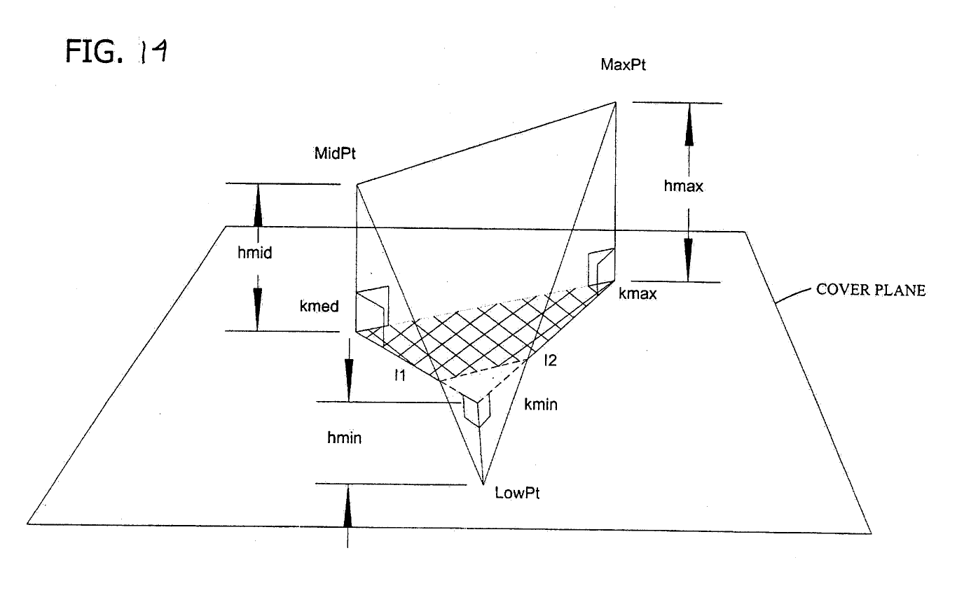

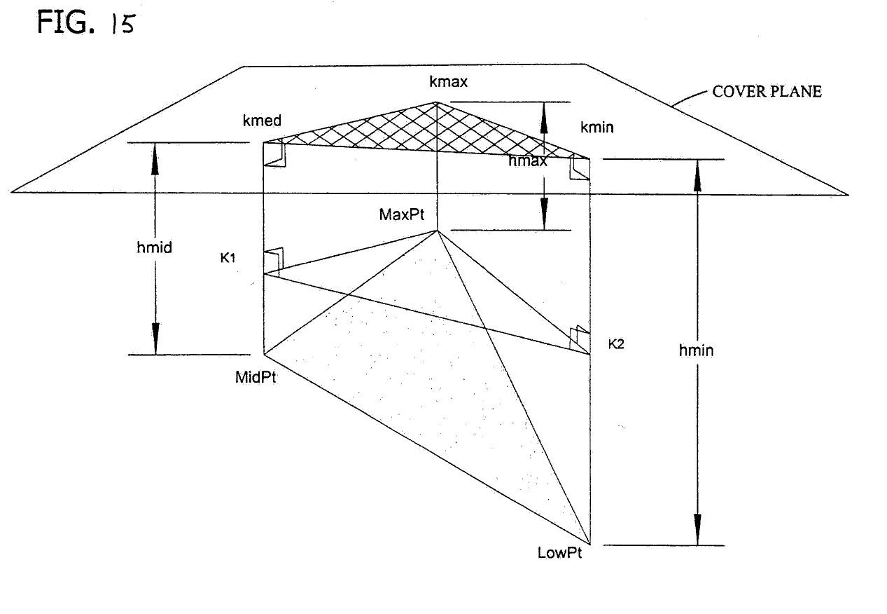

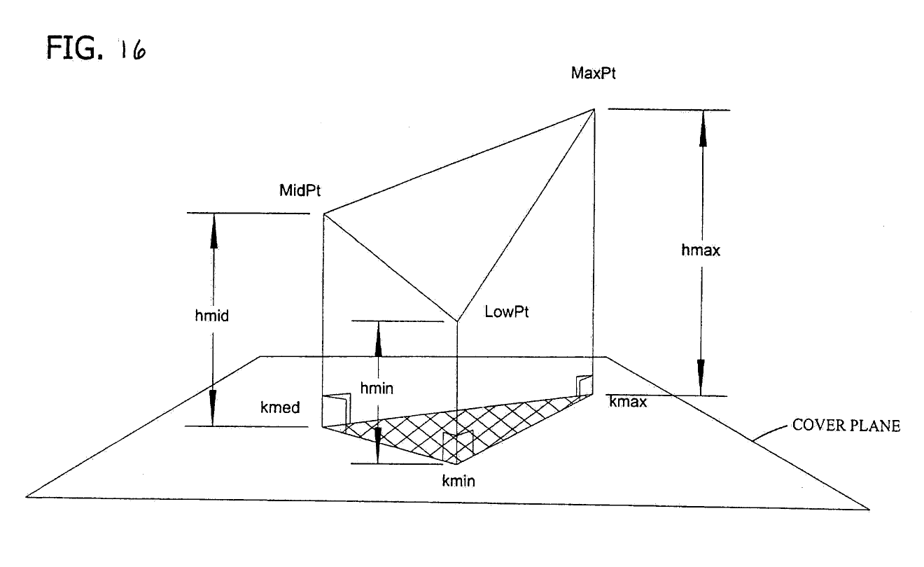

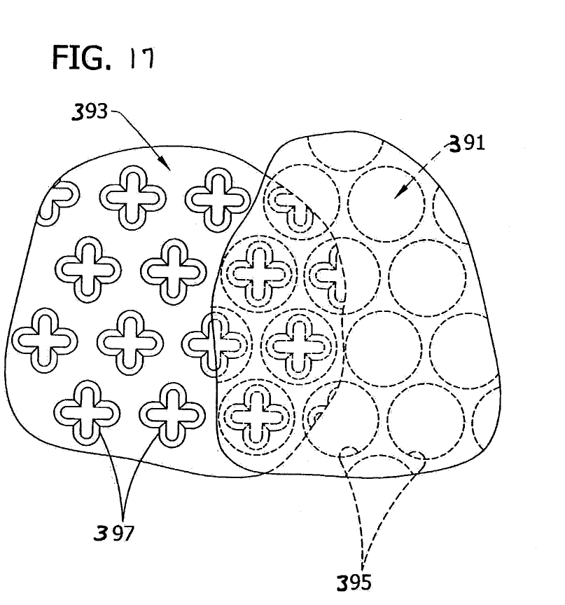

For each triangle in the upper surface 241 STL data file, the projection of the vertices of each triangle onto the Cover Plane is then calculated. With reference to FIGS. 13-16, each triangle is classified as being one of four triangle types. For triangle Type I (FIG. 13), one vertex lies above the Cover Plane and the other two vertices either lie on or lie below the Cover Plane; for triangle Type II (FIG. 14), one vertex lies above the Cover Plane, another lies on or above the Cover Plane, and the third lies below the Cover Plane; for triangle Type III (FIG. 15), at least one vertex lies below the Cover Plane and the other two either lie below the Cover Plane or lie on the Cover Plane; and for triangle Type IV (FIG. 16), all three vertices either lie on or above the Cover Plane.

In each of FIGS. 13-16, the triangle is defined by vertices indicated as LowPt, MidPt and MaxPt, with MaxPt being the vertex having the greatest, or most positive distance from the Cover Plane in the direction of the normal vector, LowPt being the vertex having the smallest, or most negative distance from the Cover Plane in the direction of the normal vector and MidPt being the remaining vertex. The designation kmax is the projection of MaxPt onto the Cover Plane, the designation kmed is the projection of MidPt onto the Cover Plane; and the designation kmin is the projection of LowPt onto the Cover Plane. The designations hmax, hmid and hmin are respective distances of the vertices from the Cover Plane, with the distance being positive if the vertex lies on the same side of the Cover Plane that the normal vector (e.g., PlaneNorm) is pointing. The line I1-I2 is the segment defined by the intersection of the triangle with the Cover Plane.

The following characteristics are then calculated:

Projected Area: The projected area corresponds to a flat area (in the horizontal plane) that would be covered by the first three dimensionally patterned stabilized absorbent layer 24 if the first three dimensionally patterned stabilized absorbent layer were laid on a flat surface. The projected area is calculated by projecting the triangles of the upper surface 241 STL data file onto the Cover Plane and summing the areas of the projected triangles. Each of the following characteristics is normalized by dividing by the projected area.

Surface Area: The surface area is the sum of the un-projected areas of all of the triangles described in the upper surface STL data file.

Open Space Under Load: The open space under load, referred to in the Whole Analysis 7 code as “volume” corresponds to the total amount of open, or air space between the liner 12 and the upper surface 241 of the first three dimensionally patterned stabilized absorbent layer 24 when the first three dimensionally patterned stabilized absorbent layer is under a 0.05 psi (0.345 kPa) load. The open space is calculated by summing the volumes defined by right triangular prisms made by each of the triangles and their respective projections onto the Cover Plane. The method for calculating the volume associated with each individual triangle depends particularly on the triangle type discussed previously. For example, the volume of a Type I triangle is the volume of the triangular pyramid defined by I1, I2, kmed and MidPt plus the volume of the rectangular pyramid defined by the points kmed, kmin, MidPt and LowPt and the apex I2. The volume of a Type II triangle is simply the volume of the triangular pyramid defined by I1, I2, kmin and LowPt. With reference to FIG. 16, the volume of a Type III triangle is calculated as the volume of a right triangular prism having a base defined by kmin, kmed and kmax and a height of hmax, plus the volume of a pyramid having a quadrilateral (K1, K2, LowPt, MidPt) as its base and the distance between MaxPt and K1 as its height. For a Type IV triangle, there is no volume between the triangle and the Cover Plane because all of the vertices of the triangle lie on or above the Cover Plane.

Contact Area Under Load: The contact area under load corresponds to the total contact area between the liner 12 and the upper surface 241 of the first three dimensionally patterned stabilized absorbent layer 24 when the absorbent article is under a uniform 0.05 psi (0.345 kPa) load. The contact area under load is calculated as the sum of the contact areas of each triangle with the Cover Plane, depending on the triangle type. For example, for Type I triangles, the contact area is the area of the triangle defined by I1, I2 and kmax. For Type II triangles, the contact area is the area of the quadrilateral defined by kmax, kmed, I1 and I2. There is no contact area for the Type III triangles because the triangle is completely below the Cover Plane. For Type IV triangles, the contact area is the area of the triangle defined by kmin, kmed and kmax.

Contact Perimeter Under Load: The contact perimeter under load corresponds to the total perimeter around the contact areas between the liner 12 and the upper surface 241 of the first three dimensionally patterned stabilized absorbent layer 24 when the absorbent article 10 is under a uniform 0.05 psi (0.345 kPa) load. The perimeter is calculated as the sum of all line segments I1-I2 defined by the intersection of the individual triangles with the Cover Plane.

Vertical Area: The vertical area corresponds to that portion of the surface area of the upper surface 241 of the first three dimensionally patterned stabilized absorbent layer 24 that is oriented generally in the thickness or z-direction, e.g., normal to the longitudinal and lateral axes of the first three dimensionally patterned stabilized absorbent layer 24. The ability of the first three dimensionally patterned stabilized absorbent layer 24 to resist overall thickness compression under load is at least in part due to the amount of material aligned in the direction of compression. The vertical area provides an indication of such an ability and is calculated as the sum of the components of the individual triangles of the upper surface 241 STL data file that are parallel to the vector normal to the Best Fit Plane and Cover Plane (e.g., PlaneNorm). This is equivalent to multiplying the surface area of the triangle by the length of the cross product between the PlaneNorm and the normal vector of the triangle.

In accordance with one embodiment of the present invention, the three-dimensional topography of the upper surface 241 of the first three dimensionally patterned stabilized absorbent layer 24 is such that the upper surface has a vertical area per projected area as determined by the Topography Analysis Method in the range of about 0.1 to about 0.5 cm²/cm², more suitably in the range of about 0.14 to about 0.4 cm²/cm², and even more suitably about 0.2 cm²/cm².

The contact perimeter under load per projected area of the upper surface 241 of the first three dimensionally patterned stabilized absorbent layer 24 as determined by the Topography Analysis Method is suitably at least about 1 cm/cm², and more suitably at least about 1.3 cm/cm².

The upper surface 241 of the first three dimensionally patterned stabilized absorbent layer 24 has an open space under load per projected area as determined by the Topography Analysis Method that is suitably in the range of about 0.05 to about 1 cm³/cm², more suitably about 0.1 to about 0.6 cm³/cm², and even more suitably about 0.3 cm³/cm². It is also contemplated that the open space under load per projected area of the upper surface 241 of the first three dimensionally patterned stabilized absorbent layer 24 as determined by the Topography Analysis Method may be greater than 1 cm³/cm².

The total surface area of the upper surface 241 of the first three dimensionally patterned stabilized absorbent layer 24 per projected area as determined by the Topography Analysis Method is suitably greater than 1.00 cm²/cm², more suitably at least about 1.05 cm²/cm², and even more suitably at least about 1.10 cm²/cm².

In one embodiment of a method of the present invention for making a first three dimensionally patterned stabilized absorbent layer 24 having a three-dimensional topography on each of the upper and lower surfaces 241, 243 of the first three dimensionally patterned stabilized absorbent layer 24, a non-woven web comprising absorbent fibers and binder material as described previously is suitably formed by conventional airlaying techniques to have generally planar (e.g., flat) upper and lower surfaces (e.g., it has not three-dimensional topography). As used herein, the term “airlaid” or “airlaying” refers to a process of producing a non-woven web wherein fibrous and/or particulate web components (e.g., the absorbent fibers, binder material and, optionally, superabsorbent material) are commingled in an air-stream and delivered onto a forming surface. There are a number of commercial processes available to produce airlaid first three dimensionally patterned stabilized absorbent layers. For example, airlaid processes are available from Danweb Corp. having offices in Risskov, Denmark, and from M&J Forming Technologies having offices in Horsens, Denmark. Suitable airlaying processes are also disclosed in U.S. Pat. Nos. 4,640,810; 4,494,278; 4,351,793 and 4,264,289.

The initial properties of the material used to make the absorbent structure will produce specific characteristics in the final topographical material. Base materials with a wide range of density can be used. They can range from 0.02 g/cc through 0.30 g/cc. Materials with lower densities tend be more formable and therefore tend to produce final topographies that have similar basis weights throughout the structure. In this instance, the peaks tend to have similar basis weights to the bottom basis weights. Higher density base materials such as those with greater than 0.12 g/cc tend to already have strong bonds that are formed in the airlaying process. When pressed to obtain the topographical surface properties they tend to stretch and can even tear. In this instance, the basis weight and density of the structure can be changed substantially. Such shifts in basis weight can lead to shifts in local density creating materials with density gradients. The design of the mold plates, the forming process method, heating method, and temperature all affect the degree of stretching and basis weight redistribution that takes place during the forming process. It is desirable to have a base sheet that has a density between 0.2 g/cc to 0.02 g/cc. It is more desirable to be in the range 0.10 g/cc to 0.04 g/cc, and even more desirable to be between 0.07 g/cc and 0.05 g/cc.

Materials that have different basis weights at the peaks than at the valleys have been shown to provide absorbent benefits. Those materials that have low basis weight at the top of the peaks compared to the basis weight in the valleys tend to have lower rewet and reduced initial (first insult) intake time. Materials that have a ratio of peak basis weight to valley basis weight less than one are desired. Those materials with less than 0.8 are more desired.

The first three dimensionally patterned stabilized absorbent layer 24 may alternatively be formed in another conventional manner, such as by being air-formed, co-formed, wet-laid, bonded-carded or formed by other known techniques in which fibrous and/or particulate materials are used to form a non-woven web. The first three dimensionally patterned stabilized absorbent layer 24 may also be a foam structure or it may be a laminate in which two or more webs are formed separately and then laminated together.

Where heat activatable binder material is present in the absorbent structure, the absorbent structure is then heated to a temperature sufficient to activate the binder material to form inter-fiber bonds within the absorbent structure, and placed between opposed mold surfaces (indicated generally at 391 and 393 in FIG. 17). For example, in one embodiment the binder material may be suitably heated to a temperature in the range of about 95° to about 200° C. As an example, where the binder fiber is T255 binder fiber commercially available from KoSa, the web is heated to at least about 230° F. (110° C.). With further reference to FIG. 17, the mold surfaces 391, 393 have respective mold patterns corresponding to the three-dimensional topographies to be imparted to the upper and lower surfaces 241, 243 of the first dimensionally patterned stabilized absorbent layer 24. The heated first dimensionally patterned stabilized absorbent layer 24 is placed between the mold surfaces 391, 393 while the binder fiber is activated so that the absorbent structure takes on some portion of the topography of the mold surfaces 391, 393. The material is subsequently allowed to cool below the activation temperature of the binder material to inhibit any further deformation of the absorbent structure, thereby maintaining the topography imparted to the upper and lower surfaces of the absorbent structure.

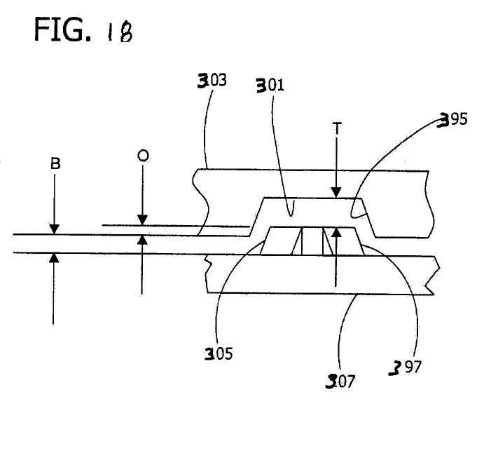

In the example illustrated in FIG. 17, portions of the mold surfaces 391, 393 are broken away to show the respective patterns on the mold surfaces. The upper mold surface 391 has depressions 395 formed therein which are generally circular in horizontal cross-section to impart generally circular surface features 245 to the upper surface 241 of the first three dimensionally patterned stabilized absorbent layer 24. The lower mold surface 393 has bumps, or pins 397 which are generally cross-shaped, or plus-shaped in horizontal cross-section to form the peaks 257 in the lower surface 243 of the first three dimensionally patterned stabilized absorbent layer 24. The depressions 395 in the upper mold surface 391 and the pins 397 of the lower mold surface 393 are suitably sized relative to each other to permit at least partial nesting of the pins within the depressions of the upper mold surface as shown in FIG. 18.

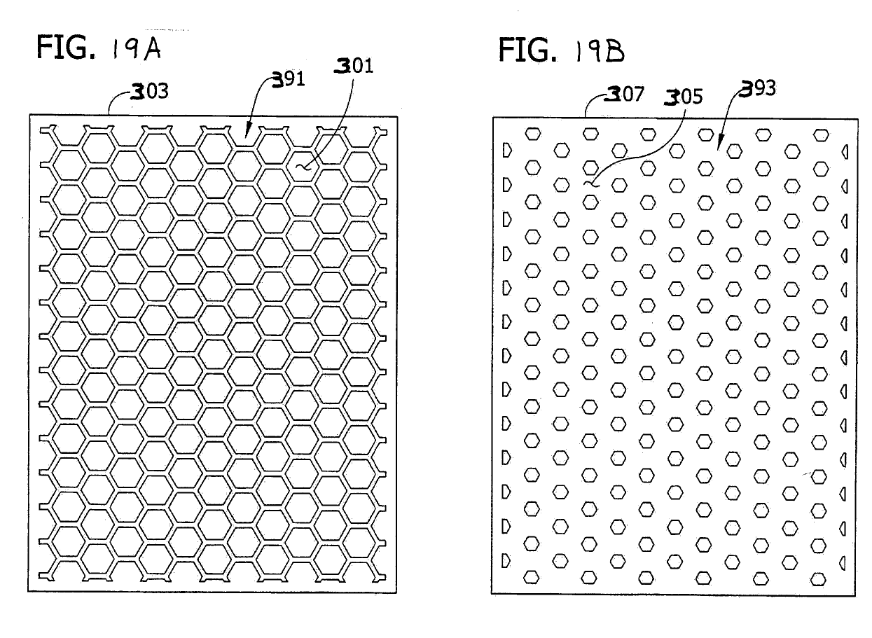

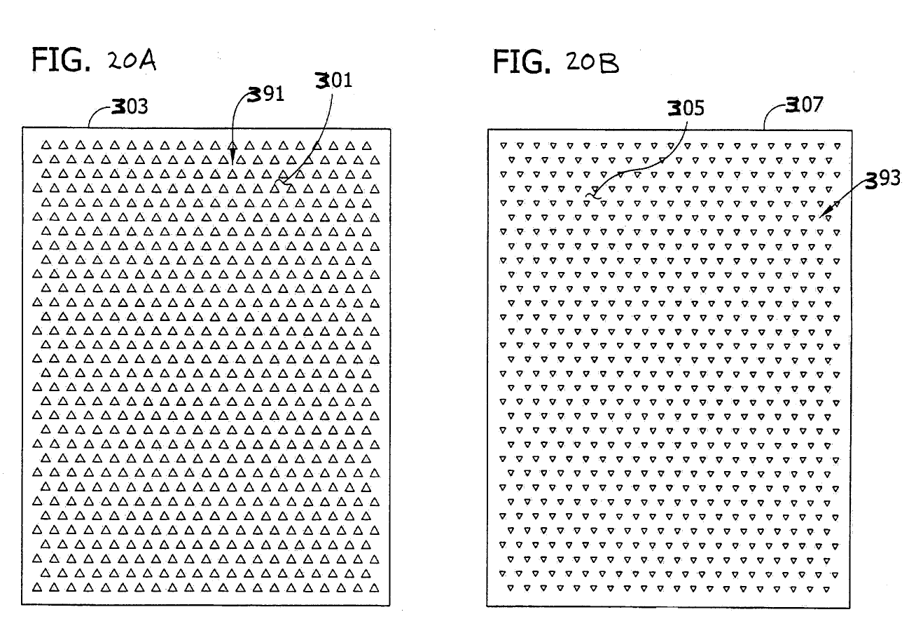

In one embodiment, such as that shown in FIGS. 19A and 19B, the opposed mold surfaces 391, 393 are respectively defined by inner surfaces 301, 305 of opposed mold plates 303, 307. The mold patterns defined by the inner surfaces 301, 305 of the mold plates 303, 307 may be non-shaped and/or otherwise substantially larger than the desired size of the first three dimensionally patterned stabilized absorbent layer 24 whereby the first three dimensionally patterned stabilized absorbent layer is cut from a larger first three dimensionally patterned stabilized absorbent layer after the three-dimensional topographies are imparted to the upper and lower surfaces 241, 243. Alternatively, the mold patterns may be substantially the same size as the desired first three dimensionally patterned stabilized absorbent layer 24 so that little or no cutting is required after molding. Additional examples of suitable mold surface patterns are shown in FIGS. 20A and 20B, 21A and 21B, and 22A and 22B and described later herein. It is understood, however, that mold surface patterns other than those shown in FIGS. 19A, 19B, 20A, 20B, 21A, 21B and 22A, 22B may be used depending on the desired three-dimensional topographies to be imparted to the upper and lower surfaces of the first three dimensionally patterned stabilized absorbent layer 24.

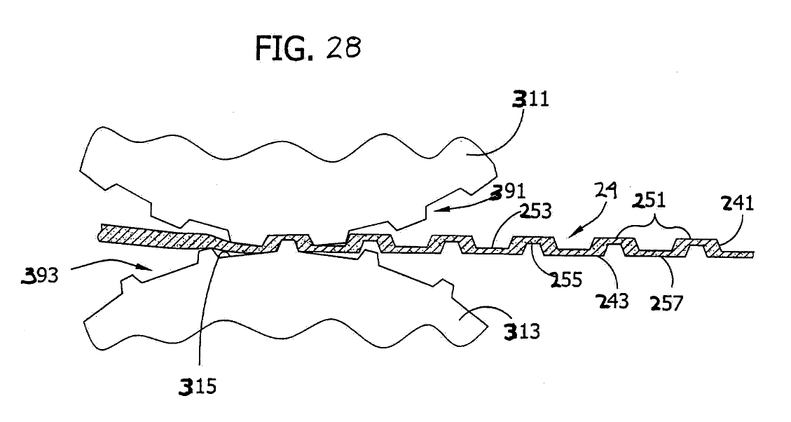

In an alternative embodiment shown in FIG. 28, the mold surfaces 391, 393 are formed on opposed rolls 311, 313 disposed on an incontinence pad or commercial feminine care pad manufacturing line (not shown). Such manufacturing lines are known to those skilled in the art for assembling feminine care pads at commercial production rates from moving webs of material as the material webs are transported in a machine direction and will not be described in further detail herein except to the extent necessary to disclose the present invention. The opposed rolls 311, 313 are disposed along the manufacturing line and are arranged relative to each other to define a nip 315 through which a first three dimensionally patterned stabilized absorbent layer web, such as a pre-formed airlaid fibrous web, passes upon movement of the web in the machine direction. The rotational speed and phasing of the opposed rolls 311, 313 is such that the patterns of the mold surfaces 391, 393 formed on the rolls intermesh as the first three dimensionally patterned stabilized absorbent layer web passes through the nip 315 defined between the rolls, thereby imparting the respective three-dimensional topographies to the upper and lower surfaces 241, 243 of the first three dimensionally patterned stabilized absorbent layer web. The web may be cut into discrete first three dimensionally patterned stabilized absorbent layers 24 downstream of the rolls 311, 313 or upstream of the rolls before the three-dimensional topography is imparted to the upper and lower surfaces of the first three dimensionally patterned stabilized absorbent layer 24.

The first three dimensionally patterned stabilized absorbent layer web is suitably heated to activate the binder material prior to the web passing through the nip 315 between the opposed rolls 311, 313. In another embodiment, only the rolls 311, 313 are heated to a temperature above the activation temperature of the binder material. In such an embodiment, the basis weight of the first three dimensionally patterned stabilized absorbent layer web may be redistributed as the three-dimensional topography is imparted to the upper and lower surfaces 241, 243 thereof, e.g., by redistributing, stretching and/or separating the absorbent fibers at the peaks 251, 255 and/or valleys 253, 257 of the upper and lower surfaces 241, 243 so that the basis weight of the first three dimensionally patterned stabilized absorbent layer 24 at the upper surface peaks is substantially less than or substantially greater than the basis weight of the first three dimensionally patterned stabilized absorbent layer at the upper surface valleys. In another embodiment, both the rolls 311, 313 and the first three dimensionally patterned stabilized absorbent layer web may be heated prior to the web entering the nip 315 formed by the rolls.

With reference back to FIG. 18, the mold surfaces 391, 393 are suitably configured relative to each other to allow a predetermined penetration depth O, or compression depth, upon urging of the mold surfaces together with the first three dimensionally patterned stabilized absorbent layer 24 between them. The penetration depth O refers to the penetration of the pins 397 of the lower mold surface 393 into the corresponding depressions 395 of the upper mold surface 391 being less than the depth at which the pins would contact the upper mold surface. The penetration depth O and the relative sizes of the pins 397 of the lower mold surface 393 and the depressions 395 of the upper mold surface 391 together define a compression thickness T at the tops of the pins (e.g., the spacing between the pins and the tops of the corresponding depressions of the upper mold surface) and a compression thickness B at the bases of the pins (e.g., the spacing between the upper mold surface at the bases of the depressions and the lower mold surface at the bases of the pins).

The compression thickness T generally defines the thickness and/or density (depending on the basis weight profile of the first three dimensionally patterned stabilized absorbent layer 24 prior to compression) of the first three dimensionally patterned stabilized absorbent layer 24 at the peaks 251 of the upper surface 241 and the compression thickness B generally defines the thickness and/or density of the first three dimensionally patterned stabilized absorbent layer 24 at the valleys 253 of the upper surface. Depending on the relative sizes of the depressions 395 of the upper mold surface 391 and the pins 397 of the lower mold surface 393, the compression thickness T and or density of the first three dimensionally patterned stabilized absorbent layer 24 at the peaks 251 of the upper surface 241 may be less than, equal to or greater than the compression thickness B of the first three dimensionally patterned stabilized absorbent layer 24 at the valleys 253 of the upper surface.

Other methods of making a three dimensional stabilized absorbent material include forming the absorbent on a screen with a three dimensional pattern and hot or cold embossing the stabilized web.

Referring again to FIG. 2, in one embodiment, the absorbent core is constructed such that the second absorbent layer 26 is arranged near the baffle 14 and positioned vertically below the first three dimensionally patterned stabilized absorbent layer 24. The absorbent core 16, however, may be constructed in any suitable manner such that at least part of the first three dimensionally patterned stabilized absorbent 24 is vertically above the second absorbent 26, when in use. The layers do not need to be the same size, shape, or coextensive with each other but may be if these arrangements are beneficial.

The second absorbent 26 includes absorbent fibers. In one embodiment, the absorbent fibers are treated with a non-fugitive densification agent. Such treatment is useful if a high density and thin second absorbent is desired. An example of treated fibers is ND-416 pulp, which contains a densification agent and is supplied by Weyerhaeuser Company of Federal Way, Wash. Alternatively, the absorbent fibers can be selected from standard Kraft pulp fibers such as NB-416, a southern pine Kraft pulp, also supplied by Weyerhaeuser if high densities are not required. One skilled in the art will appreciate that the type of absorbent fibers used in the second absorbent 26 can depend upon the final form of the product.

The second absorbent 26 may also include a superabsorbent, which may be the same as or different from the superabsorbent used in the first absorbent 24, if a superabsorbent is present in the first absorbent 24. The amount of superabsorbent used in the second absorbent 26 ranges from about 10% to about 80% by weight of the second absorbent 26, desirably from about 30% to about 60%, and more desirably from about 40% to about 55%. The amount of superabsorbent depends on the design absorbent capacity of the absorbent core of the absorbent article.

As noted above, the absorbent fibers used in the second absorbent 26 can be treated with a non-fugitive densification agent. The phrase “non-fugitive densification agent” refers to any agent that has a volatility less than water, and/or that forms a hydrogen bond or other association with the fibers, or has an affinity for the fibers and provides an ability to decrease the force required to densify the fibrous mass or absorbent containing the fibers. As a result, the second absorbent will have a tensile strength in the dry state and virtually no tensile strength in the wet state.

In addition, the second absorbent 26 may be densified using less force than would be needed if the densification agent was not present to achieve a density greater than about 0.15 g/cm³, desirably between about 0.25 g/cm³ to about 0.5 g/cm³. The density of the second absorbent will be selected based on product thickness requirements and will also be dependent on superabsorbent content. For example, if the superabsorbent content is about 50%, a density of greater than about 0.3 g/cm³ is usually desirable. Alternatively, if the superabsorbent content is lower, say about 30%, a density of 0.2 g/cm³ may be acceptable. Furthermore, if only 15% superabsorbent is present, the desirable density of the second absorbent may be lower still, around 0.15 g/cm³. A desirable absorbent fiber can be obtained from Weyerhauser Corporation under the trade designation ND-416.

Suitable non-fugitive densification agents are described in U.S. Pat. No. 6,425,979, the relevant portions of which are incorporated herein by reference. In general, therefore, the non-fugitive densification agent is selected from the group consisting of polymeric densification agents and non-polymeric densification agents that have at least one functional group that forms hydrogen bonds or coordinate covalent bonds with the fibers or exhibits an affinity for the fibers.

The polymeric densification agents may comprise polymeric densification agent molecules wherein the polymeric densification agent molecules have at least one hydrogen bonding functionality or coordinate covalent bond forming functionality. Preferred densification agents may further comprise repeating units, wherein the repeating units have such functionalities on each repeating unit of the polymer, although this is not necessary for adequate densification agent functions. In accordance with the present invention, the predetermined groups of polymeric densification agents include the group of densification agents consisting of polyglycols [especially poly(propyleneglycol)], a polycarboxylic acid, a polycarboxylate, a poly(lactone) polyol, such as diols, a polyamide, a polyamine, a polysulfonic acid, a polysulfonate, and combinations thereof. Specific examples of some of these compounds, without limitation, are as follows: polyglycols may include polypropylene glycol (PPG) and polyethylene glycol (PEG); poly(lactone) polyols include poly(caprolactone) diol and poly(caprolactone) triol; polycarboxylic acids include polyacrylic acid (PAA) and polymaleic anhydride; polyamides include polyacrylamide or polypeptides; polyamines include polyethylenimine and polyvinylpyridine; polysulfonic acids or polysulfonates include poly(sodium-4-styrenesulfonate) or poly(2-acrylamido-methyl-1-propanesulfonic acid; and copolymers thereof (for example a polypropylene glycol/polyethylene glycol copolymer). The polymeric densification agent typically has repeating units. The repeating unit may be the backbone of a compound, such as with a polypeptide, wherein the repeating polyamides occur in the peptide chain. The repeating unit may also refer to units other than backbones, for instance repeating acrylic acid units. In such a case, the repeating units may be the same or different. The densification agent has a functional group capable of forming a hydrogen bond or a coordinate covalent bond with the superabsorbent, and a functional group capable of forming a hydrogen bond with the fibers.

As used herein, a polymer is a macromolecule formed by chemical union of five or more identical or different combining units (monomers). A polyamine is a polymer that contains amine functional groups and a polyamide is a polymer that contains amide functional groups. Each of the densification agents has a hydrogen bonding or a coordinate covalent bonding functionality, and each of the densification agents may have such functionalities on each repeating unit (monomer) of the polymer. This repeating functionality may be a hydroxyl, a carboxyl, a carboxylate, a sulfonic acid, a sulfonate, an amide, an ether, an amine or combinations thereof. These densification agents are capable of forming hydrogen bonds because they have a functional group that contains an electronegative element, such as oxygen or a nitrogen.

The polyglycol has repeating ether units with hydroxyl groups at the terminal ends of the molecule. The polycarboxylic acid, such as polyacrylic acid, has a repeating carboxyl group in which a hydrogen is bound to an electronegative oxygen, creating a dipole that leaves the hydrogen partially positively charged. The polyamide (such as a polypeptide) or polyamine has a repeating NR group in which a hydrogen may be bound to an electronegative nitrogen that also leaves the hydrogen partially positively charged. The hydrogen in both cases can then interact with an electronegative atom, particularly oxygen or nitrogen, on the superabsorbent or fiber to form a hydrogen bond that adheres the densification agent to the superabsorbent and fiber. The electronegative oxygen or nitrogen of the densification agent also can form a hydrogen bond with hydrogen atoms in the superabsorbent or fiber that have positive dipoles induced by electronegative atoms, such as oxygens or nitrogens, to which the hydrogen is attached. The polyamide also has a carbonyl group with an electronegative oxygen that can interact with hydrogen atoms in the superabsorbents or fibers. Thus, the polymeric densification agents can enhance the hydrogen bonding (a) between the fibers and densification agent; and (b) in the case of superabsorbents with hydrogen bonding functionalities, between the densification agent and the superabsorbents.

Alternatively, the polymeric densification agent may form a coordinate covalent bond with the superabsorbents and a hydrogen bond to the fibers. The fibers themselves contain functional groups that can form hydrogen bonds with the densification agent, and allow the densification agent to adhere to the fiber. Cellulosic and synthetic fibers, for example, may contain hydroxyl, carboxyl, carbonyl, amine, amide, ether and ester groups that will hydrogen bond with the hydroxyl, carboxylic acid, carboxylate, amide or amine groups of the densification agent. Hence, the polymeric densification agent will adhere the superabsorbent with a coordinate covalent bond and the fiber will adhere with a hydrogen bond. Alternatively, the densification agent exhibits a high affinity for the fiber's surface such that it at least partially coats the fiber surface and remains present with minimal transfer to other surfaces in the dry state.

In some embodiments, the polymeric densification agent is bound to both the fibers and the superabsorbent by hydrogen bonds. A polypropylene glycol densification agent, for example, can be used to bind water-insoluble polyacrylate hydrogel superabsorbents to cellulosic fibers. The hydroxyl and ether groups on the glycol densification agent participate in hydrogen-bonding interactions with the hydroxyl groups on the cellulose fibers and the carboxyl groups on the polyacrylate hydrogel.

Alternatively, a polypropylene glycol (PPG) densification agent, for example, can be used to bind a water-soluble particle to cellulosic fibers. The hydroxyl and ether groups on the glycol densification agent participate in hydrogen bonding interactions with the hydroxyl groups on the cellulose fibers and appropriate functionalities on the water-soluble particle.

Therefore, the densification agent will adhere both the particle and fiber with hydrogen bonds. The presence of a hydrogen-bonding functionality on each repeating unit of the polymeric densification agent has been found to increase the number of hydrogen bonding interactions per-unit-mass of polymer, which provides superior binding efficiency and diminishes separation of materials from the fibers. The repeating ether functionality on the glycol densification agent provides this efficiency. A repeating carboxyl group is the repeating functionality on polyacrylic acid, while repeating carbonyls and NR groups (where R is H, alkyl, preferably lower alkyl i.e., less than five carbon atoms, in a normal or iso configuration) of the amide linkages are the repeating functionalities on polyamides such as polypeptides. A repeating amine group is present on polyamines.

The polymeric organic densification agents of the present invention are expected to increase in binding efficiency as the length of the polymer increases, at least within the ranges of molecular weights that are reported in the examples below. This increase in binding efficiency would be attributable to the increased number of hydrogen bonding or coordinate covalent bonding groups on the polymer with increasing molecular length. Each of the polymeric densification agents has a hydrogen bonding or coordinate covalent bonding functionality, and each such densification agent may have such functionalities on each repeating unit of the polymer. Accordingly, longer polymers provide more hydrogen bonding groups or coordinate covalent bonding groups that can participate in hydrogen-bonding interactions or in coordinate covalent bonds.

Although the invention is not limited to polymeric densification agents of particular molecular weights, polymeric densification agents having a molecular weight greater than 500 grams/mole are preferred because they provide attractive physical properties, and the solid is less volatile as compared to low-molecular-weight polymeric densification agents. Polymeric densification agents with molecular weights greater than about 4000 grams/mole are especially preferred because they have minimal volatility and are less likely to evaporate from the superabsorbents. Low-molecular weight materials typically are more mobile than are the higher-molecular weight materials. Low-molecular weight materials can more easily move to the fiber-superabsorbent interface, and are more easily absorbed by the fiber, thus making them less available to bond the superabsorbents to the fibers. The higher molecular weight materials are less apt to be absorbed by the fibers, and are less volatile than the low-molecular weight materials. As a result, higher molecular weight polymeric densification agents, to a greater extent, remain on the surface of the superabsorbents where they are more available to bond superabsorbents to fibers. In some embodiments, polymers with molecular weights between about 4000 and about 8000 grams/mole may be used. Polymers with molecular weights above about 8000 may be used, but such exceedingly high molecular weight polymers may decrease binding efficiency because of processing difficulties.

Certain polymeric densification agents have greater binding efficiency because their repeating functionality is a more efficient hydrogen bonding group. It has been found that repeating amide groups are more efficient than repeating carboxyl functionalities, which are more efficient than repeating hydroxyl functionalities, which in turn are more efficient than amine or ether functionalities. Therefore, polymeric densification agents may be preferred that have repeating amine or ether functionalities, desirably repeating hydroxyl functionalities, more desirably repeating carbonyl or carboxyl functionalities, and particularly desirable repeating amide functionalities. Binding may occur at any pH, but is suitably performed at a neutral pH of 5-8, preferably 6-8, to diminish acid hydrolysis of the resulting fibrous product. Suitable densification agents may be selected from the group consisting of polyglycols such as polyethylene glycol or polypropylene glycol, polycarboxylic acids such as polyacrylic acid, polyamides, polyamines, poly(lactone) polyols, such as poly(caprolactone) diol, and combinations or copolymers thereof.

The group consisting of polycarboxylic acids (such as acrylic acid), polyamides and polyamines has been found to have an especially good binding efficiency. Among polyamides, polypeptides are especially preferred.

As noted above, the non-fugitive densification agent may include non-polymeric densification agents. The non-polymeric densification agents have a volatility less than water. In general, they have a vapor pressure, for example, less than 10 mm Hg at 25° C., desirably less than 1 mm Hg at 25° C. The non-polymeric densification agents comprise molecules with at least one functional group that forms hydrogen bonds or coordinate covalent bonds with the fibers. In accordance with the present invention, the predetermined group of non-polymeric densification agents may include a functional group selected from the group consisting of a carboxyl a carboxylate, a carbonyl, a sulfonic acid, a sulfonate, a phosphate, a phosphoric acid, a hydroxyl, an amide, an amine, and combinations thereof (such as an amino acid or a hydroxy acid) wherein each densification agent includes at least two such functionalities, and the two functionalities are the same or different. A requirement for the non-polymeric densification agent is that it have a plurality of functional groups that are capable of hydrogen bonding, or at least one group that can hydrogen bond and at least one group that can form coordinate covalent bonds. As used herein, the term “non-polymeric” refers to a monomer, dimer, trimer, tetramer, and oligomers, although some particular non-polymeric densification agents are monomeric and dimeric, desirably monomeric.

Particularly suitable non-polymeric organic densification agents are capable of forming five or six membered rings with a functional group on the surface of the particle. An example of such a densification agent is an amine or amino acid (for example, a primary amine or an amino acid such as glycine) which forms six-membered rings by forming hydrogen bonds:

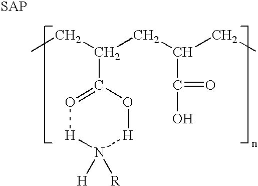

or

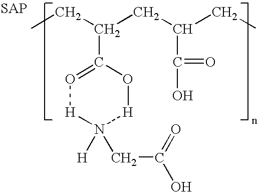

A six-membered ring also is formed by the hydroxyl groups of carboxylic acids, alcohols, and amino acids, for example:

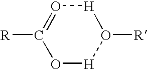

A five membered ring can be formed by the densification agent and the functionality on the surface of the particle, for example:

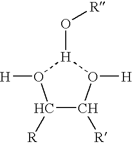

wherein the particle is a water-insoluble particle such as superabsorbent and the densification agent is an alcohol, such as a polyol with hydroxyl groups on adjacent carbons, for example, 2,3-butanediol. A densification agent that forms a five-membered ring can also be used with a water-soluble particle, for example wherein the particle is EDTA and the densification agent is an alcohol, such as a polyol with hydroxyl groups on adjacent carbons, for example, 2,3-butanediol.

Other alcohols that do not form a five-membered ring also can be used, for example alcohols that do not have hydroxyl groups on adjacent carbons. Examples of suitable alcohols include primary, secondary or tertiary alcohols.

Amino alcohol densification agents are alcohols that contain an amine group (—NR₂), and include densification agents such as ethanolamine (2-aminoethanol), and diglycolamine (2-(2-aminoethoxy)ethanol)). Non-polymeric polycarboxylic acids contain more than one carboxylic acid functional group, and include such densification agents as citric acid, propane tricarboxylic acid, maleic acid, butanetetracarboxylic acid, cyclopentanetetracarboxylic acid, benzene tetracarboxylic acid and tartaric acid. A polyol is an alcohol that contains a plurality of hydroxyl groups, and includes diols such as the glycols (dihydric alcohols) ethylene glycol, propylene glycol and trimethylene glycol; triols such as glycerin (1,2,3-propanetriol); esters of hydroxyl containing densification agents may also be used, with mono- and di-esters of glycerin, such as monoglycerides and diglycerides, being especially desired; and polyhydroxy or polycarboxylic acid compounds such as tartaric acid or ascorbic acid (vitamin C).

Hydroxy acid densification agents are acids that contain a hydroxyl group, and include hydroxyacetic acid (CH₂OHCOOH) and lactic, tartaric, ascorbic, citric, and salicylic acid. Amino acid densification agents include any amino acid, such as glycine, alanine, valine, serine, threonine, cysteine, glutamic acid, lysine, or β alanine.

Sulfonic acid densification agents and sulfonates are compounds that contain a sulfonic acid group (—SO₃H) or a sulfonate (—SO₃⁻). Amino-sulfonic acids also can be used. One example of an amino-sulfonic acid densification agent suitable for the present invention is taurine, which is 2-aminoethanesulfonic acid.

Non-polymeric polyamide densification agents are small molecules (for example, monomers or dimers) that have more than one amide group, such as oxamide, urea and biuret. Similarly, a non-polymeric polyamine densification agent is a non-polymeric molecule that has more than one amine group, such as ethylene diamine, EDTA or the amino acids asparagine and glutamine.

Although other non-polymeric organic densification agents are suitable in accordance with the discussion above, the non-polymeric organic densification agent is desirably selected from the group consisting of glycerin, a glycerin monoester, a glycerin diester, glyoxal, ascorbic acid, urea, glycine, pentaerythritol, a monosaccharide, a disaccharide, citric acid, taurine, tartaric acid, dipropyleneglycol, an urea derivative, phosphate, phosphoric acid, and combinations thereof (such as hydroxy acids).

The non-polymeric densification agent also is more desirably selected from the group consisting of glycerin, a glycerin monoester, a glycerin diester, a polyglycerin oligomer, a propylene glycol oligomer, urea and combinations thereof (such as glycerin and urea). As used herein, an oligomer refers to a condensation product of polyols, wherein the condensation product contains less than ten monomer units. A polyglycerin oligomer as referred to herein means a condensation product of two or more glycerin molecules. A propylene glycol oligomer as referred to herein means a condensation product of two or more propylene glycol molecules. The non-polymeric densification agents also may include functionalities selected from the group consisting of a carboxyl, a carboxylate, a carbonyl, a sulfonic acid, a sulfonate, a phosphate, a phosphoric acid, a hydroxyl, an amine, an amide, and combinations thereof (such as amino acids and hydroxy acids). The non-polymeric densification agents may have at least two functionalities from such group, and the groups may be the same or different.

Each of the non-polymeric densification agents disclosed above is capable of forming hydrogen bonds because it has a functional group that contains electronegative atoms, particularly oxygens or nitrogens, or has electronegative groups, particularly groups containing oxygens or nitrogens, and that also may include a hydrogen. An amino alcohol, amino acid, carboxylic acid, alcohol and hydroxy acid all have a hydroxyl group in which a hydrogen is bound to an electronegative oxygen, creating a dipole that leaves the hydrogen partially positively charged. The amino alcohol, amino acid, amide and amine all have an NR group in which a hydrogen may be bound to an electronegative nitrogen that also leaves the hydrogen partially positively charged. The partially positively charged hydrogen in both cases then can interact with an electronegative element, such as oxygen or nitrogen, on the particle or fiber to help adhere the densification agent to the particle and fiber. The polycarboxylic acid, hydroxy acid, amino acid and amide also have a carboxyl group with an electronegative oxygen that can interact with hydrogen atoms in the particles and fibers, or in intermediate molecules between the densification agent and particles or fibers. Similarly, electronegative atoms (such as oxygen or nitrogen) on the fiber or particle can interact with hydrogen atoms on the densification agent that have positive dipoles, and partially positive hydrogen atoms on the fiber or particle can interact with electronegative atoms on the densification agent.

Several proposed hydrogen bonding interactions of two of the densification agents (glycine and 1,3-propanediol) with cellulose are shown in U.S. Pat. No. 6,425,979, the relevant portion of which is incorporated herein by reference. The hydrogen bonding interactions are shown as dotted lines. One such interaction is shown between the nitrogen of glycine and a hydrogen of an —OH on cellulose. A hydrogen bond with glycine is also shown between an oxygen of the —OH on glycine and the hydroxy hydrogen of an alcohol side chain on cellulose. Hydrogen bonding interactions of the 1,3-propanediol are shown in dotted lines between an oxygen on an —OH group of the densification agent and a hydrogen of an —OH group on the cellulose molecule. Another hydrogen bond is also shown between a hydrogen on an —OH group of the glycol densification agent and an oxygen in an alcohol side chain of the cellulose.

It also is possible for water or other hydrogen bonding molecules to be interposed between the fiber and densification agent, such that the fiber and densification agent are both hydrogen bonded to the water molecule.

In some embodiments, the densification agent is bound to both the fibers and the particle by hydrogen bonds. A polyol densification agent, such as a diol, for example, can be used to bind polyacrylate hydrogel particles to cellulosic fibers. The hydroxyl groups on the polyol densification agent participate in hydrogen-bonding interactions with the hydroxyl groups on the cellulose fibers and the carboxyl groups on the polyacrylate hydrogel. As a result, the densification agent will adhere to both the particle and fiber with hydrogen bonds. These hydrogen bonds provide excellent binding efficiency and diminish separation of bound particles from the fibers.

Particularly efficient hydrogen bonding densification agents include those with carboxyl groups, such as ascorbic acid, or amide groups, such as urea. Hydroxyl groups are also very efficient densification agents. Amine and ether functionalities are less efficient densification agents.

Densification agents have functional groups that may be selected independently or in combination from the group consisting of a carboxyl, a carboxylate, a carbonyl, a hydroxyl, a sulfonic acid, a sulfonate, a phosphoric acid, a phosphate, an amide, an amine, and combinations thereof. These functional groups might be provided by the following exemplary chemical compounds: a carboxyl group could be provided by carboxylic acids, such as ascorbic acid; a carboxylate, which is an ionized carboxylic acid, could be provided by a material such as potassium citrate; a carbonyl group can be provided by an aldehyde or ketone; a hydroxyl can be provided by an alcohol or polyol, such as glycerol, or a mono- or diglyceride, which are esters of glycerol; an amide, such as a urea; and an amine, which may be provided by an alkyl amine, such as ethanolamine, wherein the densification agent has at least two of these functional groups, and each of the functional groups can be the same (for example, a polyol, polyaldehyde, polycarboxylic acid, polyamine or polyamide) or different (for example, an amino alcohol, hydroxy acid, hydroxyamide, carboxyamide, or amino acid). Functional groups also may be selected independently or in combination from the group consisting of carboxyl, an alcohol, an amide and an amine. An aldehyde may optionally be a member of each of these groups, particularly if it is oxidized to a carboxylic acid.

The second absorbent 26 can be produced on a conventional online absorbent drum former by homogeneously mixing high levels of superabsorbent and fluff pulp in a forming chamber as described in U.S. patent application Pub. No. 2002/0156441 A1 to Sawyer et. al., the relevant portions of which are incorporated herein by reference. Superabsorbent loss can be minimized by the use of a woven polyester fabric, suitably with about 300 micron pores, wrapped about the forming drum to cover the forming screens. Alternatively, micro-perforated forming screens with openings of approximately 300 microns or smaller may also be used. The openings in the fabric or screens should be small enough to trap most of the superabsorbent particles while leaving enough open area to maintain high enough permeability for pad formation.

By using an online drum former, as opposed to an offline former, extra mass and capacity of the absorbent material can be placed in zones where the material is most useful. For example, the second absorbent 26 can be formed to a specific shape, such as hourglass or the like, or extra mass can be positioned in a specific area by creating a deeper pocket in the forming screen. The second absorbent 26 may be placed on a carrier or wrap tissue or similar material. When the second absorbent 26 is formed, it leaves the forming chamber at a low density and can then be densified.

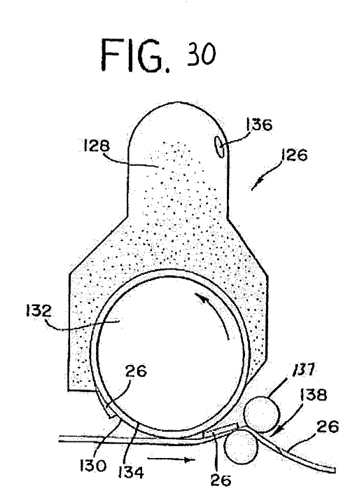

As shown in FIG. 30, the superabsorbent and the fluff pulp can be homogeneously mixed in a forming chamber 128 of the drum former 126. Man-made fibers or carrier particles can also be mixed with the superabsorbent and the fluff pulp. To minimize superabsorbent loss during forming, a porous fabric 130, such as a woven polyester fabric with approximately 300 micron pores, can be wrapped around a forming drum 132 of the drum former 126 to cover a forming screen 134 on the forming drum 132. Alternatively, fine pore, or micro-perforated, forming screens can be used in place of conventional forming screens 134. As another alternative, a light layer of fluff pulp-rich composite can be directed to the forming screens 134 prior to having the high-superabsorbent composition reach the forming screens 134 within the forming chamber 128. In any case the effective openings of the screen surface are less than 300 microns. The permeability of the forming surface must be high enough to form a uniform pad and the forming surface must be durable. This combination of properties dictates a pore size between 75 and 300 microns. The forming screens 134, whether conventional or fine pore, can be either flat screens or shaped pad zoned absorbent screens. Such a process is further described in U.S. patent application Pub. No. 2002/0156441 A1 to Sawyer et. al., the relevant portions of which are incorporated herein by reference.

By using an online drum former 126, as opposed to producing the second absorbent 26 offline, additional mass of the homogeneously mixed superabsorbent material and pulp fluff can be directed into at least one area of the second absorbent 26 where extra absorbent material would be most useful. In addition, it is easy to vary the overall absorbent capacity of the absorbent core 16 and thus the article 10 by varying the amount of superabsorbent and/or pulp fluff as desired by manufacturing and consumer requirements. As a result, capacities from 20 grams up to 1200 grams or more can easily be affected by simply using a drum former 126 as described above and by varying the amount of fluff and/or superabsorbent.

A nozzle 136 can be placed in a top front position on the forming chamber 128 to disperse the superabsorbent and to enable homogeneous mixing of the superabsorbent and the fluff pulp. Examples of such are described in U.S. Pat. Nos. 6,207,099 and 6,267,575, the relevant portions of which are incorporated herein by reference. Alternatively the nozzle 136 can be positioned to provide a gradient of composition within the second absorbent 26.

The second absorbent 26 leaves the forming chamber 128 and can be densified by using a conventional compaction roll 137 or a heated nip 138 as shown in FIG. 30. The heated nip 138 is suitably heated to about 80° to about 150° C.

The second absorbent 26 can be produced with a basis weight of between about 80 and 1000 gsm, suitably between about 100 and 800 gsm, more suitably between about 120 and 750 gsm. Once the second absorbent 26 is densified, the second absorbent can have any suitable thickness such that the overall thickness t₁ of the absorbent article 10 can have the desired thickness, as shown in FIG. 2.

During the forming process, the mixture of superabsorbent and pulp fluff can be humidified to improve densification of the resulting second absorbent 26 and provide lower cylindrical compression or stiffness values. The use of heat and humidity in the absorbent composite densification process is taught, for example, in U.S. Pat. No. 6,214,274, which is incorporated herein by reference.

Referring back to FIG. 1, the first three dimensionally patterned stabilized absorbent layer 24 and the second absorbent layer 26 can have any suitable length. For example, the second absorbent layer 26 may have a length that is less than, equal to, or greater than the length of the first three dimensionally patterned stabilized absorbent layer 24. Likewise, the first three dimensionally patterned stabilized absorbent layer 24 and the second absorbent layer 26 may have any suitable width. For example, as shown in FIG. 2, the first three dimensionally patterned stabilized absorbent layer 24 has a width greater than the width of the second absorbent layer 26. As shown in FIG. 4, the width of the first three dimensionally patterned stabilized absorbent layer 24 and the second absorbent layer 26 are substantially the same. Alternatively, and as shown in FIG. 5, the width of the first three dimensionally patterned stabilized absorbent layer 24 can be narrower than second absorbent layer 26. Additionally, the first absorbent layer 24 can be placed vertically below the second absorbent layer 26.

Referring to FIG. 2, the absorbent article 10 is shown having a thickness t₁. The thickness t₁, or caliper of the absorbent article 10 can be determined by measuring the thickness t₁ of the absorbent article 10 with a bulk tester such as a Digimatic Indicator Gauge, type DF 1050E which is commercially available from Mitutoyo Corporation of Japan. Typical bulk testers utilize a smooth platen that is connected to the indicator gauge. The platen has dimensions that are smaller than the length and width of the second absorbent layer 26. The thickness of the absorbent article 10 is generally measured under a pressure of 1.4 kPa at about room temperature (23° C.) and at about 50% relative humidity. The density in grams per cubic centimeter of absorbent materials is determined by dividing the basis weight in grams per square meter by the product of the thickness in centimeters and 10,000 (density (g/cc)=basis weight (gsm)/(thickness (cm)*10,000).

Still referring to FIG. 2, the absorbent core 16 has a thickness t₂. The thickness t₂ of the absorbent core 16 can be measured in a similar fashion as the thickness t₁ of the absorbent article 10 except that the absorbent core 16 will first be removed from the absorbent article 10.

The absorbent article 10 further is shown having a garment adhesive 40 secured to an exterior surface of the baffle 14. The garment adhesive 40 can be a hot or cold melt adhesive that functions to attach the absorbent article 10 to the inner crotch portion of an undergarment during use. The garment adhesive 40 enables the absorbent article 10 to be properly aligned and retained relative to the user's urethra or vagina so that maximum protection from the urine and/or menses can be obtained. The garment adhesive 40 can be slot coated onto the baffle 14 as one or more strips or it can be applied as a swirl pattern. The composition of the garment adhesive 40 is such that it will allow a user to remove the absorbent article 10 and reposition the article 10 in the undergarment if needed. A suitable garment adhesive 40 that can be used is Code Number 34-5602 which is commercially available from National Starch and Chemical Company. National Starch and Chemical Company has an office located at 10 Finderne Avenue, Bridgewater, N.J.

In order to protect the garment adhesive 40 from contamination prior to use, a releasable peel strip 42 is utilized. The peel strip 42 can be formed from paper or treated paper. A standard type of peel strip 42 is a white Kraft peel paper coated on one side so that it can be easily released from the garment adhesive 40. The user removes the peel strip 42 just prior to attaching the absorbent article 10 to the inner crotch portion of his or her undergarment. Three suppliers of the peel strips 42 include Tekkote, International Paper Release Products, and Namkyung Chemical Ind. Co., Ltd. Tekkote has an office located at 580 Willow Tree Road, Leonia, N.J. 07605. International Paper Release Products has an office located at 206 Garfield Avenue, Menasha, Wis. 54952. Namkyung Chemical Ind. Co., Ltd. has an office located at 202-68 Songsan-ri, Taean-eup, Hwaseoung-kum, Kyunggi, Korea. Absorbent articles that are not attached to the user's underwear such as disposable diapers and adult incontinence garments (briefs, undergarments, protective underwear) do not require garment adhesive.

### EXAMPLES

The following examples are presented to more fully describe the present invention and should not be interpreted as limiting the invention in any way.

### Example 1

An experiment was conducted to determine the intake and rewet performance characteristics of first three dimensionally patterned stabilized absorbent layers 24 formed in accordance with the present invention. In the experiment, first three dimensionally patterned stabilized absorbent layers 24 were formed from about 90% by weight fluff pulp commercially available from Weyerhauser of Federal Way, Wash., U.S.A. as model designation NF-401 and about 10% by weight bicomponent binder fiber commercially available from KoSa of Houston, Tex., U.S.A. as model designation T255. The first three dimensionally patterned stabilized absorbent layers 24 were initially airlaid by a suitable airlaying process as described previously and were sized or otherwise cut to approximately 8 inches (21.6 cm) by 11 inches (28 cm). One set of first three dimensionally patterned stabilized absorbent layers 24 was formed to have a generally uniform basis weight of about 120 grams per square meter (gsm) and another set was formed to have a generally uniform basis weight of about 225 gsm. The actual basis weight was suitably within ±5% of the target basis weight. The absorbent structures were formed to have an average density (prior to processing that created the surface topography) in the range of about 0.054 g/cc to about 0.066 g/cc.

Mold plates 303, 307 used to form the three-dimensional topography on the upper and lower surfaces 241, 243 of certain ones of the absorbent structures included the mold plates shown in FIGS. 19A, 19B, 20A, 20B, and 21A, 21B, each measuring about 5 inches by about 20 inches (12.7 cm by about 50.8 cm) and the mold plates shown in FIGS. 22A, 22B, each measuring about 8.5 inches by 11 inches (about 21.6 cm by 27.9 cm). The mold plates 303, 307 were placed in a heated platen press, such as that available from Carver Press of Wabash, Ind., U.S.A., under model #3895 4D10A00. The surface area of the outer (flat) surface of one of the mold plates 303 was measured and the pressure required to apply approximately 6,500 psi (44,817.5 kPa) was calculated. For example, the flat surface area of the mold plate 303 of FIG. 22A was about 600 cm², requiring a platen pressure of about 10,000 psi (68,950 kPa). The platen press was pre-heated to about 230° F. (110 C).

After the platen press was heated, the mold plates were heated by pressing them in the platen press for 42 seconds without any material. Additional pre-heating of the plates was done on any plate that had not recently been used. The base sheet was placed centrally on the lower mold plate 307 so that approximately 0.25 inches (0.635 cm) of the lower plate extended out beyond the ends and side edges of the first three dimensionally patterned stabilized absorbent layer 24. The upper mold plate 303 was then placed over the lower mold plate 307, with the exposed portion of the lower mold plate used to align the plates. The exposed portion of the lower mold plate 307 and the upper mold plate 303 were partially pressed into each other to ensure proper alignment of the plates. The required pressure was then applied to the mold plates 303, 307 to thereby compress the first three dimensionally patterned stabilized absorbent layer 24 and, as described previously, to impart the mold surface patterns to the upper and lower surfaces 241, 243 of the first three dimensionally patterned stabilized absorbent layer 24. The plates were pressed together for 42 seconds, and then opened. The mold plates and material were removed from the press. The top plate was carefully removed from the material to prevent deformation of the material before the binder material had cooled below its melt point.

Five different mold surface patterns were used, one to impart a compressed but otherwise flat (non-three-dimensional) topography to the upper and lower surfaces 241, 243 of the first three dimensionally patterned stabilized absorbent layer 24 and four different patterns to impart four different three-dimensional topographies to the upper and lower surfaces of the first three dimensionally patterned stabilized absorbent layer 24.

1) FIGS. 19A and 19B illustrate mold plates 303, 307 having mold surfaces 391, 393 patterned to impart a three-dimensional topography to the upper and lower surfaces 241, 243 wherein the peaks 251, 255 of the upper and lower surfaces are generally hexagonal in horizontal cross-section. The hexagon shaped depressions 395 in the upper mold plate 303 (FIG. 19A) are spaced center to center from each other at a distance of about 2.0 cm and are sized to have a cross-sectional dimension of about 0.8 cm to provide a surface feature density on the upper surface 241 of the first three dimensionally patterned stabilized absorbent layer 24 of about 0.29 per square centimeter of projected area. The side length of the hexagon was 5.0 mm. The depth of the bond pattern was 3.0 cm.

2) FIGS. 20A and 20B illustrate mold plates 303, 307 having mold surfaces 391, 393 patterned to impart a three-dimensional topography to the upper and lower surfaces 241, 243 wherein the peaks 251, 255 of the upper and lower surfaces are generally triangular in horizontal cross-section. The triangular shaped depressions 395 in the upper mold plate 303 (FIG. 20A) are spaced center to center from each other a distance of about 0.9 cm and are sized approximately 0.55 cm triangle base by 4.5 cm triangle height and provide a surface feature density on the upper surface 241 of the first three dimensionally patterned stabilized absorbent layer 24 of about 1.18 per square centimeter of projected area. The side length of the triangles was 5.0 mm. The depth of the bond pattern was 0.3 cm.

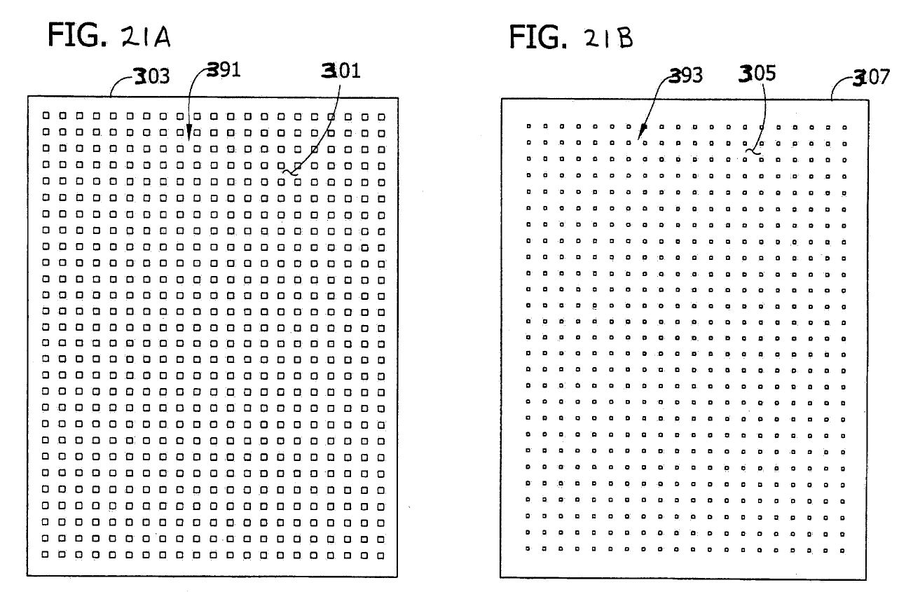

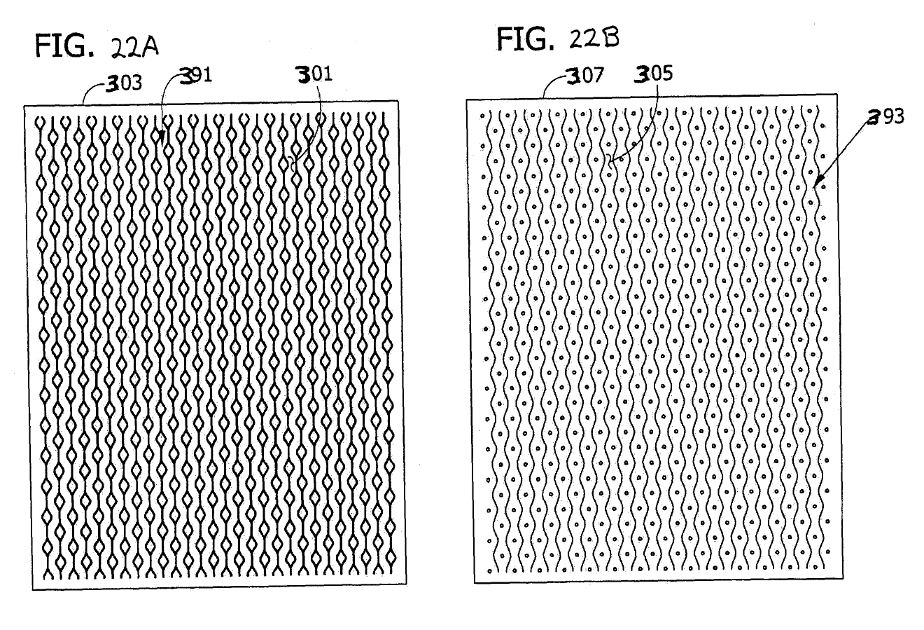

3) FIGS. 21A and 21B illustrate mold plates 303, 307 having mold surfaces 391, 393 patterned to impart a three-dimensional topography to the upper and lower surfaces 241, 243 wherein the peaks 251, 255 of the upper and lower surfaces are generally square in horizontal cross-section. The square depressions 395 in the upper mold plate 303 (FIG. 21A) are spaced center to center from each other a distance of about 0.95 cm and are sized to have a cross-sectional dimension of about 0.27 cm and to provide a surface feature density on the upper surface 241 of the first three dimensionally patterned stabilized absorbent layer 24 of about 2.2 per square centimeter of projected area. The side length of the squares on the upper mold plate was 3.5 mm and the side length of the squares on the lower mold plate was 3.0 mm. The depth of the bond pattern was 0.3 cm.

4) FIGS. 22A and 22B illustrate mold plates having mold surfaces configured to impart a three-dimensional topography to the upper and lower surfaces 241, 243 wherein some of the peaks 251, 255 and valleys 253, 257 of the upper and lower surfaces 241, 243 are generally serpentine and others are generally circular in horizontal cross-section. The serpentine channels formed in the upper mold plate are generally about 0.46 cm in cross-section and provide a surface feature density of about 0.79 per square cm of projected area. The width of the bond pattern on the upper surface of the mold plate was 0.8 mm. The depth of the bond pattern was 0.3 cm. The serpentine pattern had a portion that was approximately a sine wave with a wavelength of 1.75 cm and an amplitude of 0.24 cm. The bottom mold plate also had a pattern depth of 0.3 cm and a bond pattern width of 0.8 mm at its upper surface. The sinusoidal wave portion of the pattern had an amplitude of 0.24 cm and wavelength of 1.75 cm. The circular portion had a diameter of 1.0 mm.

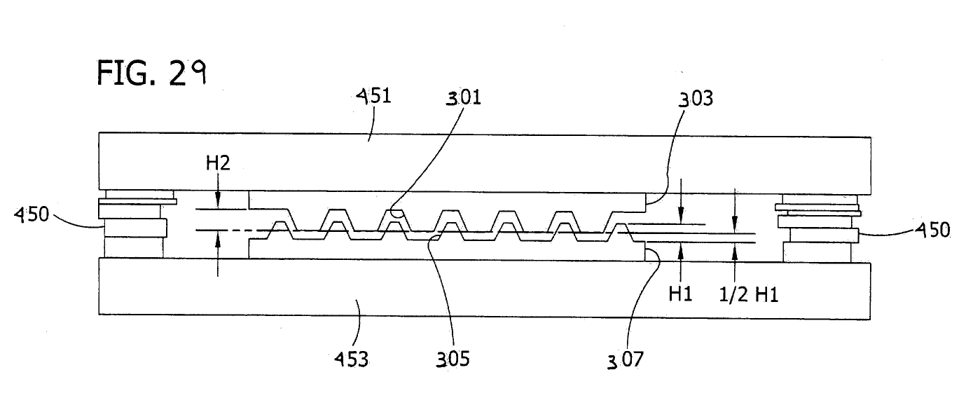

The first three dimensionally patterned stabilized absorbent layers were compressed between the mold plates 303, 307 to either a full penetration depth O (FIG. 18) or to one-half of the penetration depth for a duration of 42 seconds. With reference to FIG. 29, to achieve a one-half penetration depth, the depth of the mold surface pattern on each of the upper and lower mold plates 303, 307 of a respective pair of plates was measured to determine which plate had the smallest depth (the smallest depth being labeled as H1 and the depth of the other plate being H2 in FIG. 29). This depth (H1) was then divided by two. Metal shim stock 450 was placed between upper and lower platens, respectively designated 451 and 453 in FIG. 29. The shim stock thickness was chosen so that when the plates 303, 307 were urged together by the platens 451, 453, penetration of the pins on the mold surface of the plate opposite the plate having the smallest depth was limited to one-half the smallest penetration depth (H1). First three dimensionally patterned stabilized absorbent layers made at “full” penetration depth were made without shim stock to limit the penetration of one plate into another. The full pressure of the press is exerted onto the material to impart the topography into the web.

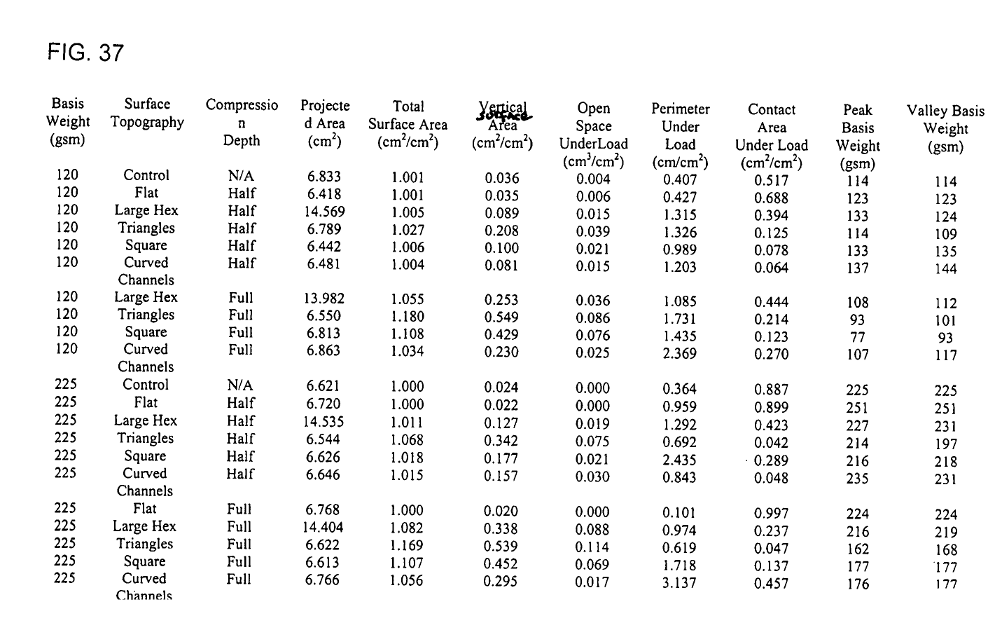

The various first three dimensionally patterned stabilized absorbent layers 24 formed for testing are set forth in the table of FIG. 37, Two control first three dimensionally patterned stabilized absorbent layers 24 (one having a gsm of about 120 and the other having a gsm of about 225) were not further processed after air-laying (e.g., they remained uncompressed and had no three-dimensional topography).

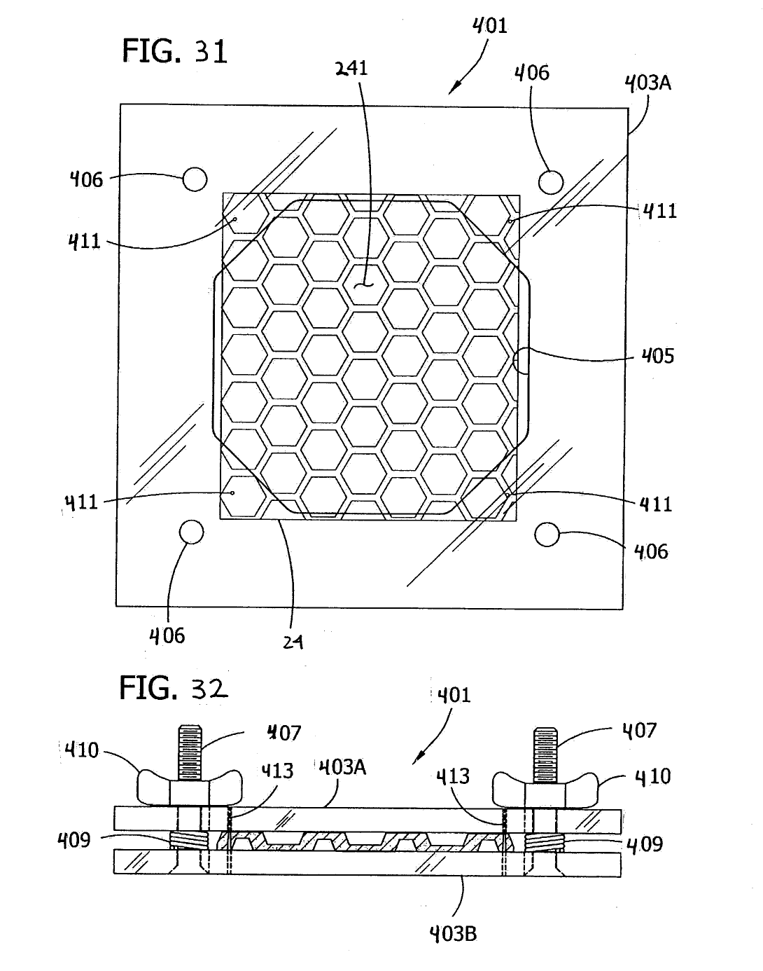

For each first three dimensionally patterned stabilized absorbent layer 24, 4 inch by 4 inch (10.16 cm by 10.16 cm) samples were cut therefrom, taking care not to stretch or otherwise distort the material. Samples of each absorbent structure were split randomly into two sets. Samples from one set were used to measure their menses simulant intake and rewet properties. Samples from the second set were used to measure the overall thickness of the sample for later use with the Topography Analysis Method. These samples were also sent to Laser Design Inc. of Minneapolis, Minn. for scanning. FIGS. 31 and 32 illustrate a sample holder, generally indicated at 401, for holding the first three dimensionally patterned stabilized absorbent layer sample during scanning. The sample holder 401 generally comprises a pair of opposed, acrylic plates 403a, 403b, each having dimensions of about 13.5 cm by 13.5 cm and a central, generally octagonal opening 405. Bolt holes 406 (four of them) are disposed generally adjacent the corners of each plate 403a, 403b to accommodate a bolt 407 and a coil spring 409 axially mounted on the bolt between the plates. A wing nut 410 is threadably received on each bolt 407. A set of four pin holes 411 is also formed in each plate 403a, 403b to receive retaining pins 413 therethrough for purposes which will be described. At least one insert (not shown) is sized for being received in the octagonal opening 405 of the lower plate 403b. Alternate sample holding fixtures can be designed to hold materials that are smaller without departing from this general approach. Fixtures must be capable of holding the material in a flat state without movement and allow simultaneous unobstructed viewing of both sides of the material.

To scan the first three dimensionally patterned stabilized absorbent layer sample, the lower plate 403b of the sample holder 401 was placed face down on a flat surface with the bolts 407 extending up through the bolt holes 406 in the lower plate and the insert was inserted into the central octagonal opening 405. The first three dimensionally patterned stabilized absorbent layer sample was centrally placed on the lower plate 403b. The springs 409 were then axially mounted on the bolts 407 and the upper plate 403a was placed over the first three dimensionally patterned stabilized absorbent layer sample with the bolts passing outward through the bolt holes 406 in the upper plate. The wing nuts were threaded onto the bolts 407 and tightened until the plates 403a, 403b just touched the upper and lower surfaces 241, 243 of the first three dimensionally patterned stabilized absorbent layer sample. The retaining pins 413 were inserted through the pin holes 411 in the upper plate 403a and into the first three dimensionally patterned stabilized absorbent layer sample to retain the sample in the holder 401. The holder 401 (with the sample retained therein) was then lifted off of the flat surface, leaving the insert, and positioned on the scanning device for scanning. Each of the upper and lower surfaces 241, 243 of the sample was then scanned to derive point cloud data. The point cloud data was converted into triangle data which was then converted into the upper surface (or “front”) STL data file, and the combined (upper and lower surface) STL data file.

The STL data files corresponding to each of the samples were then subjected to the Topography Analysis Method set forth herein to determine various upper surface characteristics of the first three dimensionally patterned stabilized absorbent layers. More particularly, three subsets of each STL data file, each subset corresponding to either an approximately 1 inch by 1 inch (2.54 cm by 2.54 cm) square portion of the first three dimensionally patterned stabilized absorbent layer sample or to a square portion of the first three dimensionally patterned stabilized absorbent layer sample sized sufficient to contain at least one and a half full repeats of the upper surface topography pattern in both the longitudinal and lateral directions, were generated. The subsets were analyzed using the Topography Analysis Method and the results were averaged to determine the projected area, total surface area, vertical area, contact area under load, perimeter under load and open space under load defined by the upper surface of each sample. The results are tabulated in the table shown in FIG. 37, with the total surface area, vertical area, contact area under load, perimeter under load and open space under load normalized by dividing by the projected area.

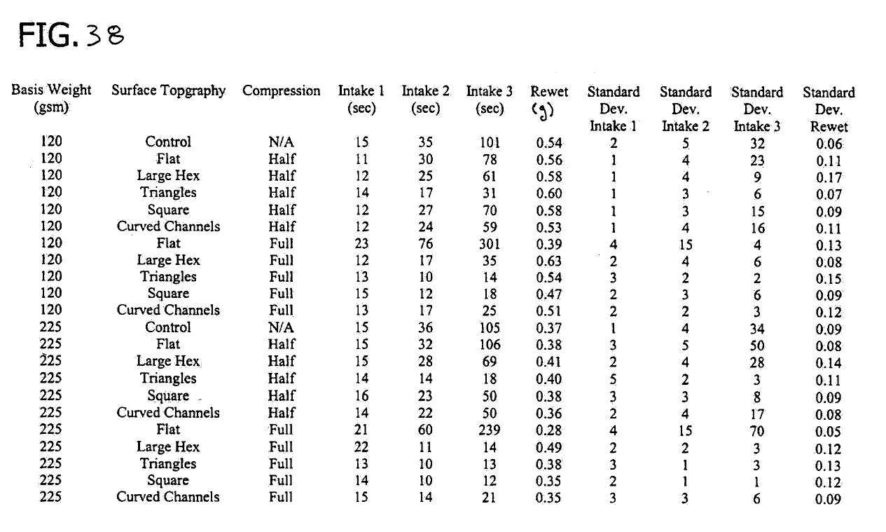

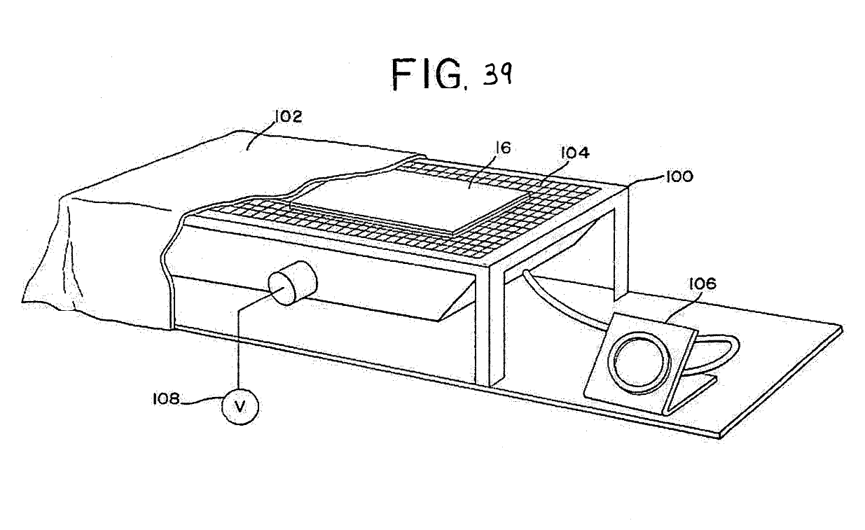

Additional 4 inch by 4 inch (10.16 cm by 10.16 cm) first three dimensionally patterned stabilized absorbent layer samples of the subject first three dimensionally patterned stabilized absorbent layers 24 were used to perform a Menses Simulant Intake and Rewet Test as set forth later herein to determine the liquid intake and rewet properties of the first three dimensionally patterned stabilized absorbent layers. Intake measures the amount of time needed for a liquid, e.g., menses, to be taken into the first three dimensionally patterned stabilized absorbent layer 24 upon repeated insults thereof. Rewet measures the amount of liquid, e.g. menses, that flows back to the outer surface of the first three dimensionally patterned stabilized absorbent layer 24 (after taking in at least three insults) upon the application of a compressive pressure to the first three dimensionally patterned stabilized absorbent layer. The results of the Menses Simulant Intake and Rewet Test are provided in the table of FIG. 38.

Typically, there is an inverse relationship between intake results and rewet results as evidenced by comparing the materials with the flat topography at half and full depth in the table of FIG. 38. The one-half penetration depth flat samples had better intake times (faster intake) and worse rewet (higher rewet) than the flat samples with the full penetration depth compression (e.g., having higher density). However, first three dimensionally patterned stabilized absorbent layers formed in accordance with the present invention simultaneously improved both intake and rewet.

Results from this experiment were used to generate a linear regression model that used the topographical features of the upper surface of the first three dimensionally patterned stabilized absorbent layer samples as the independent variables, and the intake/rewet results as the dependent variables. Simple regression analysis was done to verify the independence of the topographical features. A relevant statistical model was found for each intake and for the rewet. The statistics for the models are as follows:

| | Adjusted R-Square for | Likelihood the model is |
|---|---|---|
| Predicted Property | model | actually a constant. |
| 1^{st} intake | 0.41 | 0.01 |
| 2^{nd} intake | 0.77 | <0.001 |
| 3^{rd} intake | 0.69 | 0.002 |
| Rewet | 0.79 | <0.001 |

Thus, the topographical properties of the upper surface of the first three dimensionally patterned stabilized absorbent layer as determined by the Topography Analysis Method are meaningful drivers for controlling liquid movement, and in particular menses simulant intake and rewet, in first three dimensionally patterned stabilized absorbent layers. Using this information it is possible to design first three dimensionally patterned stabilized absorbent layers having surface topographies that provide desired absorbent properties.

Menses Simulant Intake and Rewet Test

The Menses Simulant Intake and Rewet Test determines differences between first three dimensionally patterned stabilized absorbent layers designed for absorption of menses in the rate of intake and the amount of flow back to the surface (e.g., rewet) of the first three dimensionally patterned stabilized absorbent layer under pressure when at most three insults of menses simulant are applied to the first three dimensionally patterned stabilized absorbent layer, with time allowed for the simulant to distribute within the first three dimensionally patterned stabilized absorbent layer between insults.

For each of the tests done in the experiment, one of the first three dimensionally patterned stabilized absorbent layer samples described previously and set forth in the table of FIG. 37 was used as the upper layer in a two layer system. The lower layer was of equal size relative to the upper layer and comprised a 225 gsm airlaid material made with 75% NF-416 fluff pulp from Weyerhaeuser, 10% T-255 bicomponent binder fiber from KoSa, and 15% SXM-9543 Superabsorbent particles from Stockhausen. Additionally a 0.6 osy (20 gsm) spunbond fabric was used as a liner overlaying the upper layer and contained 0.45% Ahcovel surfactant.

Equipment Needed:

5 ml capacity pipettor (such as those commercially available under the name Pipetman P5000, available from Gilson Inc., Middleton, Wis.);

Small beaker;

Menses simulant warmed in bath for 10 minutes to 26° C.;

Blotter paper—Verigood, White cut to about 7.6 cm by 15.2 cm. Two sheets per first three dimensionally patterned stabilized absorbent layer being tested;

Small spatula or stirrer;

5 ml funnels for rate block;

Stop watch

One or two timers

Gauze or paper towels for clean up

10% CHLOROX solution

Electronic balance accurate to 0.01 grams

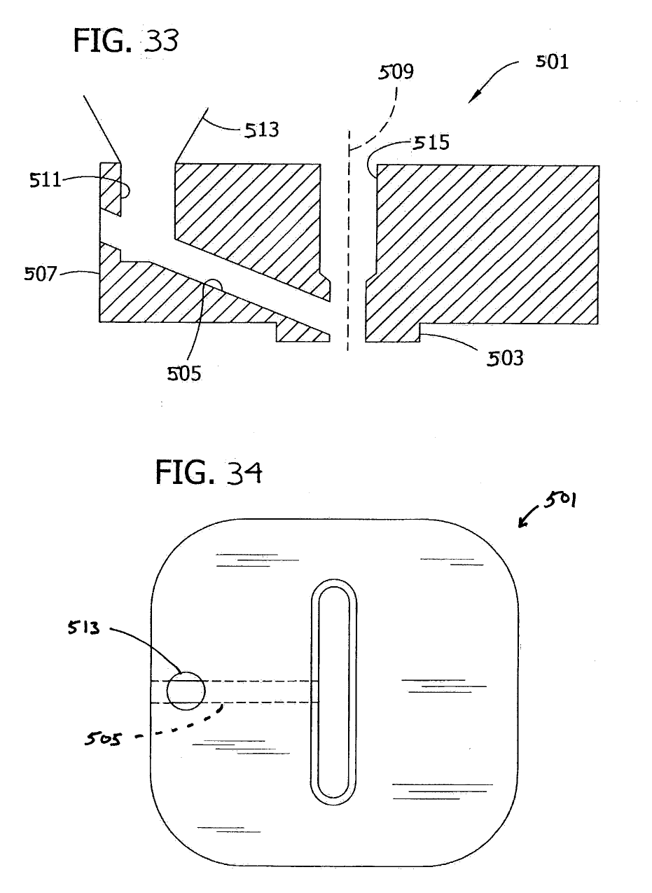

Rate block (FIGS. 33 and 34)

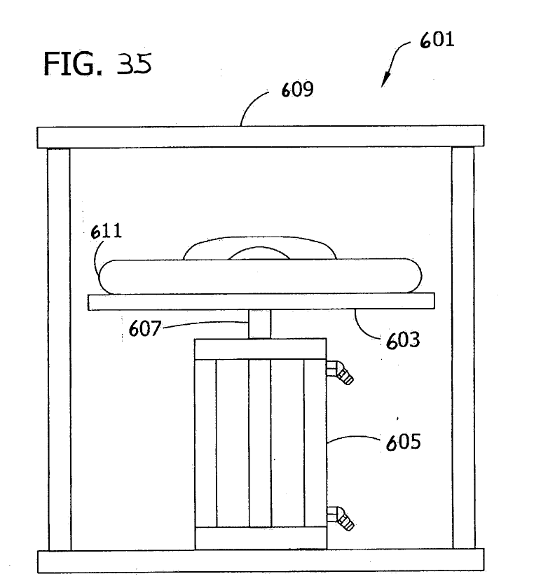

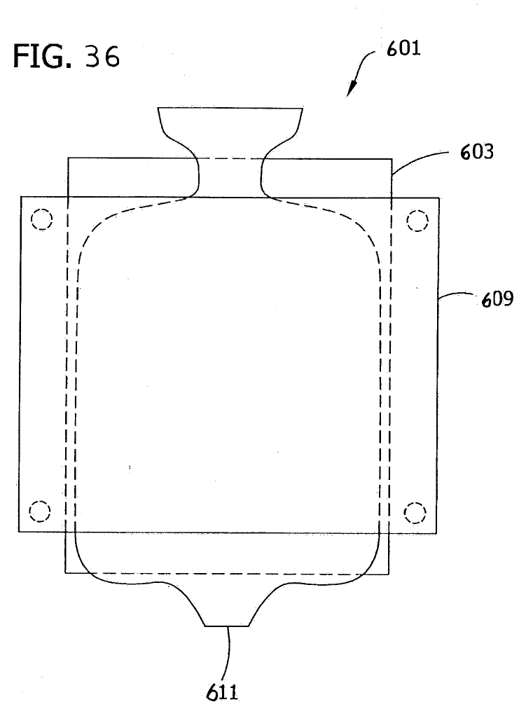

Rewet Stand (see FIGS. 35 and 36)

Rate Block

The rate block (shown in FIGS. 33 and 34, and indicated generally at 501) is made of clear acrylic and is 3 inches (76.2 mm) wide by 2.87 inches (72.9 mm) deep (into the page) by 1.25 inches (31.8 mm) in height. The rate block 501 includes a central portion 503 projecting out from the bottom of the block and having a height of about 0.125 inches (3.2 mm) and a width of about 0.886 inches (22.5 mm). The rate block 501 has a channel 505 with an inside diameter of 0.188 inches (4.8 mm) that extends diagonally downward from one side 507 of the rate block to a center line 509 thereof at an angle of about 22 degrees from horizontal. The channel 505 may be made by drilling the appropriately sized hole from the side 507 of the rate block 501 at the proper angle beginning at a point 0.716 inches (18.2 mm) above the bottom of the rate block; provided, however, that the starting point of the drill hole in the side must be subsequently plugged so that menses simulant will not escape therefrom. The rate block has an average weight of 161.9 grams and therefore exerts a pressure of 0.62 kPa over an area of 25.6 cm².

A top hole 511 has a diameter of about 0.312 inches (7.9 mm), and a depth of 0.625 inches (15.9 mm) so that it intersects the channel 505. The top hole 511 is centered 0.28 inches (7.1 mm) from the side 507 and is sized for receiving a funnel 513 therein. A center bore 515 allows viewing of the progression of the menses simulant as it is taken into the first three dimensionally patterned stabilized absorbent layer and is ovate in cross-section. The center bore 515 is centered width-wise on the rate block 501 and has a bottom hole width of 0.315 inches (8 mm) and enlarges in size from the bottom of the rate block, for ease of viewing, to a width of 0.395 inches (10 mm). The top hole 511 and center hole 515 may also be drilled into the rate block 501.

Rewet Stand

The test stand (shown in FIGS. 35 and 36 and indicated generally at 601) comprises a 7.75 inch by 10 inch (19.7 cm by 25.4 cm) platen 603 supported by a pneumatic cylinder 605 and piston 607 below a fixed plate 609. A hot water bottle 611 sized approximately 7.5 inches by about 10.75 inches and filled with water is seated on the platen 603 for supporting the sample to be tested. The piston 607 is moveable via pneumatic pressure within the cylinder 605 to raise the platen 603 (and the hot water bottle 611 and sample supported by the platen) toward the fixed plate 609 to generally squeeze the sample between the hot water bottle and the fixed plate 609. The pressure within the cylinder 605 is regulated by a suitable pressure regulator (not shown). The hot water bottle 611 distributes pressure evenly across the test sample, which may or may not have the same height in the center than it does at its edges. For that reason the hot water bottle 611 must be sufficiently filled to allow equal redistribution of the pressure.

Menses Simulant:

The menses simulant used for the Menses Simulant Intake and Rewet Test is intended to simulate menses in its liquid handling properties. The simulant is made by Cocalico Biologicals, Inc. of Reamstown, Pa., U.S.A. and is composes of swine blood and chicken egg whites. It has a Hematocrit value of 30%±2% and a bioburden of <250 CFU/ml. Such a menses simulant is known to those skilled in the art and is described in U.S. Pat. No. 5,883,231, which is incorporated herein by reference. Established guidelines for handling blood-borne pathogens, including personal protection, handling and post-use sterilization must be followed when working with the swine blood based menses simulant.

Prior to using the menses simulant for the Menses Simulant Intake and Rewet Test, the simulant is removed from the refrigerator and placed in a water bath for 10 minutes at 26° C. Before cutting open the bag for use, the bag is massaged between hands for a few minutes to mix the simulant, which will have separated in the bag. The bag tubing is then cut and the amount of simulant needed for testing is poured into the small beaker. The simulant in the beaker is stirred slowly with the small spatula to mix thoroughly.

Test Procedure:

The two blotters are weighed dry. The rate block 501 is then placed in the center of the sample to be tested and the sample is insulted with about 2.0±0.01 ml of the menses simulant from the pipettor into the funnel 513. The stopwatch and timer are started simultaneously with the first insult. The time needed for the simulant to be fully taken into the first three dimensionally patterned stabilized absorbent layer sample is recorded as the first intake time (e.g., in seconds). The stopwatch is started at the beginning of the insult and stopped when the fluid has been absorbed below the liner. The timer remains on and is used to indicate when subsequent insults are completed. If a ring of simulant remains around the inside of the rate block 501, this should be ignored.

When the timer indicates nine minutes have elapsed since the start of the test, a second insult of 2±0.01 ml of menses simulant is applied to the first three dimensionally patterned stabilized absorbent layer sample and the time needed to taken in the simulant is recorded as the second intake time. When the timer indicates eighteen minutes have elapsed since the start of the test the procedure is repeated for a third insult to measure and record a third intake time. In the event the intake time is greater than nine minutes, the test is stopped for that sample.

When the timer indicates twenty-seven minutes have elapsed since the start of the test, the rate block 501 is removed from the sample and the two dry, pre-weighed blotters are placed on top of the sample. The sample and blotters are together placed on the rewet stand and a uniform 1.0 psi (6.9 kPa) pressure is applied to the first three dimensionally patterned stabilized absorbent layer for a period of 180 seconds. The blotters are removed and weighed. The amount of rewet, in grams weight, is the difference between the weight of the blotters when wet and the weight of the blotters when dry.

The Menses Simulant Intake and Rewet Test is conducted on five first three dimensionally patterned stabilized absorbent layer samples and the results are averaged to obtain the intake times and rewet for a particular first three dimensionally patterned stabilized absorbent layer.

When multiple lots of menses simulant are used, each sample to be tested is randomly assigned to a particular lot of simulant.

### Example 2

Absorbent core materials were made and incorporated into prototype pantiliners. The absorbent core included a first three dimensionally patterned stabilized absorbent layer, described below, that was placed over fluff/superabsorbent absorbent layers as described in the table below with a dimension of 40 mm by 150 mm. The upper layer of stabilized absorbent had a dogbone shape with an area of 83.6 cm², a length of 170 mm, a width at the widest bulb of 60 mm and 45 mm at the narrowest point. A bodyside liner of 22 gsm Sandler Sawabond 4346 BCW liner (comprised of 100% polypropylene staple fibers) material was placed on the bodyside of the pad and a water impervious polyethylene film on the garment side. (Note: Sandler Vliesstoffe, Christian Heinrich Sandler GmbH & Co. KG, Lamitzmuhle 1, D-95126 Schwarzenbach/Saale, Germany).

The first three dimensionally patterned stabilized absorbent had the following general composition:

The materials were airlaid

90% NF-401 partially debonded pulp from Weyerhaeuser

10% KoSa 6 mm 2 d T255 PE/PET binder fiber (35100-A merge number)

Basis weight of 120 gsm,

Density of 0.06 g/cm³

The first three dimensionally patterned stabilized absorbent material was used to make several three dimensionally patterned stabilized absorbents.

Five patterns were made by pressing into forming plates at 10,000 psi (69,000 kPa) at 240° F. (116° C.) for 42 seconds.

The control material was not pressed.

The pantiliners were tested using the Menses Simulant Intake and Rewet Test, described above. Table 1 provides the results.

TABLE 1

| | Insult 1 | Insult 2 | Insult 3 | Rewet |
|---|---|---|---|---|
| Code | (secs) | (secs) | (secs) | (grams) |
| 1. Control/ND-416 lower | 10.6 | 167.8 | >1200 | 0.44 |
| layer | | | | |
| 2. Cross Circle pattern, | 9.4 | 56.2 | 175.2 | 0.46 |
| bumps “down” (FIG. 7), ND- | | | | |
| 416 lower layer | | | | |
| 3. Small squares (FIG. 8), | 12.0 | 72.9 | 521.9 | 0.45 |
| ND-416 lower layer | | | | |
| 4. Curved channels with | 8.5 | 159.2 | >1200 | 0.56 |
| cones (FIG. 9), ND-416 | | | | |
| lower layer | | | | |
| 5. Channel Hex (FIG. 11), | 10.4 | 132.4 | >1200 | 0.52 |
| ND-416 lower layer | | | | |
| 6 Squares, ND-416 lower | 10.5 | 81.5 | 804 | 0.52 |
| layer | | | | |

Note: ND-416 Lower layers were 40% Dow 2035 superabsorbent, 60% pulp (ND 416) at a density of 0.32 g/cc and a basis weight of 500 gsm.
Note: N = 2 for samples. Materials to make samples were very limited. No standard deviations reported.
Note: Timing was stopped after 1200 seconds for codes 1, 4, and 5. After timing was stopped the block was removed and the fluid absorbed and rewet was then completed.

Example 2 in Table 1 clearly shows differences in menses simulant intake rates among the samples. In particular, codes 2, 3, and 6 have better intake times. All three have large “macro” depressions which allow the simulant to enter and be absorbed. They have more open space than do codes 1, 4, and 5. Codes 4 and 5 have more open area than does code 1 and are slightly faster on the first and second insults.

### Example 3

Saline Intake and Flowback Test

The saline intake and flowback test is used to measure the fluid intake time and flowback of adult incontinence pads. The fluid intake time is measured by using a timing device and visually estimating the length of time required to absorb three individual fluid insults. The fluid is 0.9% by weight sodium chloride dissolved in deionized water along with about 0.004 g/liter FD&C Blue #1 dye to make the liquid more visible. The test is typically done at room temperature (about 21° C.).

Layers of blotting paper are provided under the specimen (an incontinence pad) to collect any testing fluid that may flow over the side of the specimen. Apparatus for conducting this test include a four ounce capacity funnel part number 06122-20 available from Cole-Parmer Instrument Company (www.coleparmer.com) or equivalent. Additionally, a test board (a cylinder with a 25.4 mm inside diameter mounted on a plexiglass plate that fits on top of a mounting board and the test sample is mounted between the plate and the board) available from Kimberly-Clark Corporation, a stopwatch, and a pump, syringe, or beaker to pour the liquid into the cylinder are required.

For small samples the liquid was poured into the test board cylinder tube by hand. The sample is placed in the test board and secured (by pressing) on the board to insure a secure seal. A five milliliter insult was poured into the tube and the stopwatch started. One skilled in the art will understand that the insult size or volume is typically adjusted to be appropriate to the product being tested. For example, a five milliliter insult volume is appropriate for an incontinence pantiliner such as POISE pantiliners produced by Kimberly-Clark Corporation with offices in Irving, Tex.).

As soon as the fluid was totally absorbed (visual observation), the time was recorded. After one minute, the procedure was repeated for the second insult. After another minute, the procedure was repeated for a third 5 ml insult. A longer time means it takes that sample longer to absorb a fluid insult. Typically, lower times are better because the product tested will be less likely to leak in use.

Liquid Saturated Retention Capacity Test

The following test can be conducted to determine the amount of fluid retained by the absorbent core 16 and/or absorbent article 10. The liquid saturated retention capacity is determined as follows. The material to be tested, having a moisture content of less than about 7 weight percent, is weighed and submerged in an excess quantity of a 0.9 weight percent aqueous saline solution at room temperature (about 23° C.). The material to be tested is allowed to remain submerged for 20 minutes. After the 20 minute submerging, the material is removed and, referring to FIG. 39, placed on a TEFLON™ coated fiberglass screen 104 having 0.25 inch (0.6 cm) openings (commercially available from Taconic Plastics Inc., Petersburg, N.Y.) which, in turn, is placed on a vacuum box 100 and covered with a flexible rubber dam material 102. A vacuum of about 0.5 pound per square inch (about 3.5 kilopascals) is drawn on the vacuum box for a period of about 5 minutes with the use of, for example, a vacuum gauge 106 and a vacuum pump 108). The material being tested is then removed from the screen and weighed.

The amount of liquid retained by the material being tested is determined by subtracting the dry weight of the material from the wet weight of the material (after application of the vacuum), and is reported as the absolute liquid saturated retention capacity in grams of liquid retained. If desired, the weight of liquid retained may be converted to liquid volume by using the density of the test liquid, and is reported as the liquid saturated retention capacity in milliliters of liquid retained. The lower the number, the less fluid the product can retain under pressure.

For relative comparisons, this absolute liquid saturated retention capacity value can be divided by the weight of the tested material to give the specific liquid saturated retention capacity in grams of liquid retained per gram of tested material. If material, such as hydrogel-forming polymeric material or fiber, is drawn through the fiberglass screen while on the vacuum box, a screen having smaller openings should be used. Alternatively, a piece of tea bag or similar material can be placed between the material and the screen and the final value adjusted for the liquid retained by the tea bag or similar material.

The pantiliners were tested using the Retention Capacity test and the Saline Intake and Flowback test, both described above. Table 2 provides the results.

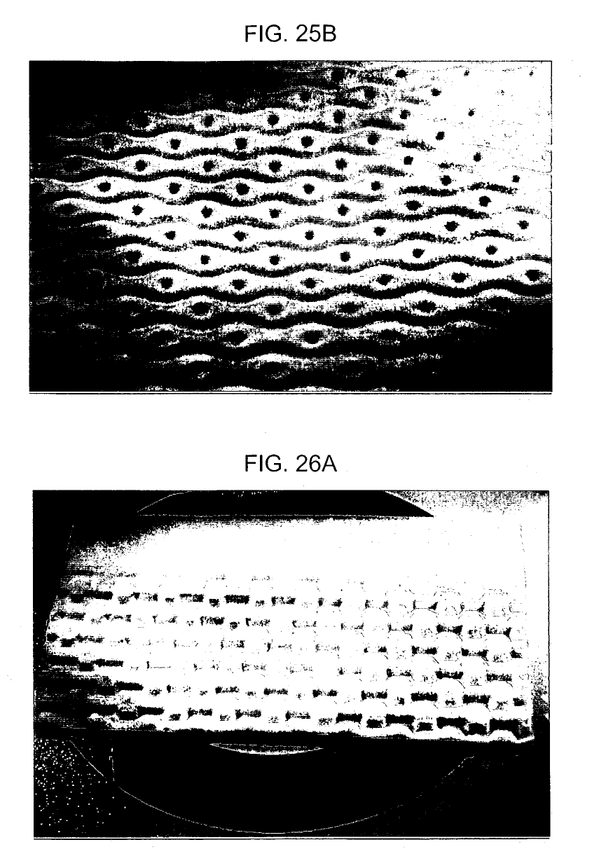

TABLE 2

| | Insult 1 | Insult 2 | Insult 3 | Flowback | Ret. Cap, | Bulk |
|---|---|---|---|---|---|---|
| Code | (secs) | (secs) | (secs) | (grams) | (grams) | (mm) |
| 1. Control/ND-416 | 3.1 | 5.7 | 7.2 | 1.0 | 54.5 | 3.2 |
| lower layer | (0.62) | (0.36) | (0.83) | (0.26) | (5.7) | (0.24) |
| 2. Cross Circle pattern, | 2.6 | 4.3 | 5.6 | 1.0 | 52.2 | 3.7 |
| bumps “down” (FIG. | (0.26) | (0.96) | (1.2) | (0.53) | (6.7) | (0.08) |
| 23B), ND-416 lower | | | | | | |
| layer | | | | | | |
| 3. Small squares (FIG. | 3.7 | 4.6 | 6.1 | 1.6 | 52.2 | 3.4 |
| 24), ND-416 lower layer | (0.42) | (0.66) | (0.82) | (0.07) | (2.3) | (0.05) |
| 4. Curved channels | 4.3 | 6.6 | 7.5 | 1.7 | 51.4 | 3.2 |
| with cones (FIG. 25A), | (0.93) | (0.31) | (0.73) | (0.42) | (6.8) | (0.09) |
| ND-416 lower layer | | | | | | |
| 5. Channel Hex (FIG. | 4.3 | 6.2 | 8.0 | 1.0 | 57.7 | 3.6 |
| 26A), ND-416 lower | (0.29) | (0.35) | (0.15) | (0.21) | (3.6) | (0.09) |
| layer | | | | | | |
| 6. Squares (FIG. 27), | 2.5 | 3.8 | 5.2 | 1.5 | 55.2 | 2.9 |
| ND-416 lower layer | (0.04) | (0.23) | (0.21) | (0.69) | (4.9) | (0.17) |
| 7. Control, NB-416 | 3.4 | 5.8 | 7.7 | 0.4 | 57.1 | 3.3 |
| lower layer | (0.42) | (0.41) | (0.17) | (0.39) | (3.0) | (0.07) |
| 8. Channel Hex (FIG. | 3.9 | 5.9 | 8.0 | 1.1 | 52.4 | 3.1 |
| 26A), NB-416 lower | (0.07) | (0.29) | (0.34) | (0.46) | (3.6) | (0.05) |
| layer | | | | | | |

Note: Both lower layers were 40% Dow 2035 superabsorbent, 60% pulp (ND or NB, see table) at a density of 0.32 g/cc and a basis weight of 500 gsm.
Note: N = 3 for all data. ( ) are standard deviations.
Note: Each insult (#1, #2, #3) size was 5 ml.

The data in Table 2 shows only small saline intake and flowback differences among the codes. Codes 2 and 5 seem to have somewhat better flowback performance. Visually, codes 2 through 6 and code 8 stood out compared to Codes 1 and 7 because of the texturing of the first three dimensionally patterned stabilized absorbent layer (see FIGS.).

While the invention has been described in conjunction with specific embodiments, it is to be understood that many alternatives, modifications, and variations will be apparent to those skilled in the art in light of the foregoing description. Accordingly, this invention is intended to embrace all such alternatives, modifications, and variations that fall within the spirit and scope of the appended claims.

What is claimed:

1. An absorbent core for use in an absorbent article comprising:
a. a first three dimensionally patterned stabilized absorbent layer; and,
b. a second absorbent layer adjacent the first absorbent layer.

2. The absorbent core of claim 1 wherein the first absorbent layer has at least one region of high basis weight and at least one region of low basis weight to define a three dimensional pattern.

3. The absorbent core of claim 1 wherein the first absorbent layer comprises absorbent fibers.

4. The absorbent core of claim 1 wherein the first absorbent layer comprises a superabsorbent.

5. The absorbent core of claim 1 wherein the second absorbent layer contains hydrophilic fibers.

6. The absorbent core of claim 1 wherein the second absorbent layer contains fluff fibers.

7. The absorbent core of claim 6 wherein the second absorbent layer contains a mixture of fluff fibers and superabsorbent.

8. The absorbent core of claim 7 wherein the mixture of fluff fibers and superabsorbent is unstabilized.

9. The absorbent core of claim 8 wherein the fluff fibers are treated with a non-fugitive densification agent.

10. The absorbent core of claim 1 further comprising a surge layer.

11. The absorbent core of claim 10 wherein, in use, the first absorbent layer is vertically above the second absorbent layer.

12. The absorbent core of claim 1 wherein the first absorbent layer is selected from the group consisting of airlaid, wet laid, coform, meltblown fibers, bonded carded webs, tissue laminates, absorbent films, foams, and combinations thereof.

13. The absorbent core of claim 1 wherein the first absorbent layer is an airlaid layer.

14. The absorbent core of claim 13 wherein the airlaid layer comprises a quantity of absorbent fibers, a quantity of superabsorbent, and a quantity of binder material.

15. The absorbent core of claim 1 wherein the first absorbent layer contains from 0 to about 60% superabsorbent.

16. The absorbent core of claim 1 wherein the second absorbent layer contains from about 10% to about 80% superabsorbent.

17. The absorbent core of claim 15 wherein the second absorbent layer contains from about 10% to about 80% superabsorbent.

18. The absorbent core of claim 1 wherein the second layer includes absorbent fibers treated with a non-fugitive densification agent.

19. The absorbent core of claim 18 wherein non-fugitive densification agent forms hydrogen bonds and is selected from the group consisting of polymeric densification agents, non-polymeric densification agents, and mixtures thereof.

20. The absorbent core of claim 18 wherein non-fugitive densification agent is selected from the group consisting of propylene glycol, glycerin, and mixtures thereof.

21. The absorbent core of claim 18 wherein the non-fugitive densification agent is a polymer having a molecular weight between about 4,000 and about 8,000 gm/mole.

22. The absorbent core of claim 18 wherein the non-fugitive densification agent is a polymer having a molecular weight greater than about 8,000 gm/mole.

23. The absorbent core of claim 1 wherein the first three dimensionally patterned stabilized absorbent layer has a basis weight generally at the peaks of the upper surface, the basis weight being substantially less than a basis weight of the first three dimensionally patterned stabilized absorbent layer generally at the valleys of the upper surface.

24. An absorbent core for use in an absorbent article comprising:
a. a first three dimensionally patterned stabilized absorbent layer having a longitudinal axis, a lateral axis and a z-direction axis normal to the longitudinal and lateral axes, the first three dimensionally patterned stabilized absorbent layer comprising longitudinally opposite ends, laterally opposite side edges, an upper surface having a three-dimensional topography relative to the longitudinal and lateral axes and defining a plurality of peaks and valleys of the upper surface relative to the z-direction, and a lower surface having a three-dimensional topography relative to the longitudinal and lateral axes and defining a plurality of the peaks and valleys of the lower surface relative to the z-direction, the first three dimensionally patterned stabilized absorbent layer having a projected area as determined by a Topography Analysis Method, the upper surface of the first three dimensionally patterned stabilized absorbent layer having a vertical area as determined by the Topography Analysis Method of at least about 0.1 cm² per 1.0 cm² projected area of the first three dimensionally patterned stabilized absorbent layer; and,
b. a second absorbent layer adjacent the first absorbent layer wherein the second absorbent layer contains a material selected from fluff fibers, a superabsorbent, fluff fibers treated with a non-fugitive densification agent, absorbent fibers treated with a non-fugitive densification agent, and mixtures thereof.

25. The absorbent core of claim 24 wherein the second absorbent layer contains a mixture of fluff fibers and a superabsorbent.

26. The absorbent core of claim 25 wherein the mixture of fluff fibers and superabsorbent is unstabilized.

27. The absorbent core of claim 24 further comprising a surge layer.

28. The absorbent core of claim 27 wherein, in use, the first absorbent layer is vertically above the second absorbent layer.

29. The absorbent core of claim 24 wherein the first absorbent layer contains from 0 to about 60% superabsorbent.

30. The absorbent core of claim 24 wherein the second absorbent layer contains from about 10% to about 80% superabsorbent.

31. The absorbent core of claim 29 wherein the second absorbent layer contains from about 10% to about 80% superabsorbent.

32. The absorbent core of claim 24 wherein the upper surface of the first three dimensionally patterned stabilized absorbent layer has a vertical area as determined by the Topography Analysis Method in the range of about 0.1 cm² to about 0.5 cm² per 1.0 cm² projected area of the first three dimensionally patterned stabilized absorbent layer.

33. The absorbent core of claim 32 wherein the upper surface of the first three dimensionally patterned stabilized absorbent layer has a vertical area as determined by the Topography Analysis Method of at least about 0.2 cm² per 1.0 cm² projected area of the first three dimensionally patterned stabilized absorbent layer.

34. The absorbent core of claim 24 wherein the upper surface of the first three dimensionally patterned stabilized absorbent layer has a contact perimeter under load as determined by the Topography Analysis Method of at least about 1.0 cm per 1.0 cm² projected area of the first three dimensionally patterned stabilized absorbent layer.

35. The absorbent core of claim 34 wherein the upper surface of the first three dimensionally patterned stabilized absorbent layer has an open space under load as determined by the Topography Analysis Method in the range of about 0.05 to about 1.0 cm³ per 1.0 cm² projected area of the first three dimensionally patterned stabilized absorbent layer.

36. The absorbent core of claim 35 wherein the upper surface of the first three dimensionally patterned stabilized absorbent layer has an open space under load as determined by the Topography Analysis Method of at least about 0.3 cm³ per 1.0 cm² projected area of the first three dimensionally patterned stabilized absorbent layer.

37. The absorbent core of claim 24 wherein the upper surface of the first three dimensionally patterned stabilized absorbent layer has an open space under load as determined by the Topography Analysis Method in the range of about 0.05 to about 1.0 cm³ per 1.0 cm² projected area of the first three dimensionally patterned stabilized absorbent layer.

38. The absorbent core of claim 24 wherein the first three dimensionally patterned stabilized absorbent layer has a basis weight generally at the peaks of the upper surface, the basis weight being substantially equal to a basis weight of the first three dimensionally patterned stabilized absorbent layer generally at the valleys of the upper surface.

39. The absorbent core of claim 24 wherein the first three dimensionally patterned stabilized absorbent layer comprises absorbent fibers and binder material.

40. The absorbent core of claim 39 wherein the binder material comprises from about 2 to about 80 percent by weight of the first three dimensionally patterned stabilized absorbent layer.

41. The absorbent core of claim 24 in combination with the absorbent article, the absorbent article comprising a liner, an outer cover and the first three dimensionally patterned stabilized absorbent layer disposed between the liner and the outer cover whereby the upper surface of the first three dimensionally patterned stabilized absorbent layer generally faces the liner and the lower surface of the first three dimensionally patterned stabilized absorbent layer generally faces the outer cover.

42. The absorbent core of claim 24 wherein the first three dimensionally patterned stabilized absorbent layer comprises at least about 0.1 peaks per 1.0 cm² projected area of the first three dimensionally patterned stabilized absorbent layer.

43. The absorbent core of claim 24 wherein the first three dimensionally patterned stabilized absorbent layer has an average basis weight in the range of about 60 to about 1500 grams per square meter.

44. The absorbent core of claim 43 wherein the upper surface of the first three dimensionally patterned stabilized absorbent layer has a vertical area as determined by the Topography Analysis Method in the range of about 0.1 cm² to about 0.5 cm² per 1.0 cm² projected area of the first three dimensionally patterned stabilized absorbent layer.

45. An absorbent core for use in an absorbent article comprising:
a. a first three dimensionally patterned stabilized absorbent layer; and,
b. a second absorbent layer adjacent the first absorbent layer wherein the second absorbent layer contains a material selected from fluff fibers, a superabsorbent, fluff fibers treated with a non-fugitive densification agent, absorbent fibers treated with a non-fugitive densification agent, and mixtures thereof.

46. The absorbent core of claim 45 wherein the first absorbent layer has a first surface containing a first pattern of peaks and valleys and a second and opposite surface containing a second pattern of peaks and valleys.
